(19) United States
(12) Patent Application Publication
(10) Pub. No.: US 2025/0135463 A1
(43) Pub. Date: May 1, 2025

(54) SHREDDER

(71) Applicant: FELLOWES, INC., Itasca, IL (US)

(72) Inventor: Dmitry ROMANOVICH, Wheaton, IL (US)

(21) Appl. No.: 18/927,645

(22) Filed: Oct. 25, 2024

Related U.S. Application Data
(60) Provisional application No. 63/546,149, filed on Oct. 27, 2023.

(51) Int. Cl. B02C 18/16

(52) U.S. Cl. CPC B02C 18/16; B02C 2018/166

(57) ABSTRACT

A shredder includes a shredder mechanism and a lubricant system. Each of a first and second plurality of strippers includes a first and second lubricant tubing opening formed therethrough. The first and second lubricant tubing openings are aligned with one another to form a first and second lubricant tubing passage through the first and second plurality of strippers. A lubricant delivery tubing is communicated in a closed loop to a lubricant reservoir and routed through both the first and second lubricant tubing passages. The closed loop enabling the lubricant to flow from the lubricant reservoir, through the lubricant delivery tubing and back to the lubricant reservoir. The lubricant delivery tubing is permeable to the liquid lubricant through a surface thereof along portions disposed within the first and second lubricant tubing passages for delivering a portion of the liquid lubricant flowing therethrough to lubricate the strippers and the cutter blades.

### BACKGROUND

This application claims priority to U.S. Provisional Patent Application Ser. No. 63/546,149, filed Oct. 27, 2023, which is hereby incorporated by reference in its entirety.

### FIELD

The present patent application relates to shredders, and particularly a lubricant system that is configured to be used in a shredder to provide lubrication to the shredder, and a shredder mechanism that is configured to shred an article (e.g., at least paper), etc.

### DESCRIPTION OF RELATED ART

Shredders are well known devices for destroying articles, such as paper, documents, compact discs (“CDs”), expired credit cards, etc. Typically, users purchase shredders to destroy sensitive information bearing articles, such as credit card statements with account information, documents containing company trade secrets, etc.

A shredder may generally include a shredder mechanism contained within a housing that is removably mounted atop a container. The shredder mechanism typically includes a cutter mechanism with a series of cutter elements that shred articles fed into the shredder mechanism and discharge the shredded articles downwardly into the container. Examples of known shredders include U.S. Pat. No. 9,724,704 titled “shredder thickness with anti-jitter feature”; U.S. Pat. Nos. 8,757,526 and 9,573,135 titled “shredder with thickness detector”; U.S. Pat. No. 7,798,435 titled “shredder with oiling mechanism”; U.S. Pat No. 7,344,096 titled “shredder with lock for on/off switch”; U.S. Pat. No. 7,946,515 titled “shredder throat safety system”; U.S. Pat . No. 9,346,059 titled “shredder with vibration performance sensor and control system”; U.S. Pat. No. 8,882,011 titled “cutting shaft oil manifold”; and U.S. Pat. No. 9,283,567 titled “shredder with jam proof system”. These patents are commonly owned by the same assignee as the present patent application. The present patent application incorporates each of these patents herein by reference in their entirety.

As with other mechanical devices, wear in the shredder may be reduced and performance of the shredder may be maintained by proper lubrication of moving parts in the shredder. In particular, wear on cutter elements/blades of the shredder mechanism and load on the shredder motor may be reduced by oiling the cutter elements of the shredder mechanism. Oiling or oil sheets are a convenient way to maintain the shredders. Prior to the use of these oil sheets, manual oiling into a paper feed throat of the shredder was the standard way to lubricate shredder's cutter mechanism. Some methods included directly dripping the oil/lubricant manually onto the shredders while other methods included oiling onto a sheet of paper and, as the sheet of paper begins to saturate, shred the sheet of paper in the cutter mechanism of the shredder. Other methods to maintain the cutter elements or cutter mechanism of the shredders with oil/lubricant include a variety of auto-oil systems as well.

U.S. Patent Application Publication No. 2010/0327092 (“the Application '092”) discloses a shredder with a stripper in its shredder mechanism. FIG. 5 shows a blade tip right up against an opposing stripper. FIG. 5 shows a terminating end of the elongated paper restrictor since the paper can only be displaced within the lower section after and about the paper restrictor's termination end/point.

The present patent application endeavors to provide various improvements over prior mentioned examples of the lubricant systems of shredders or the shredder mechanisms of shredders along with any similar examples that may not have been mentioned or included.

### SUMMARY

In one embodiment of the present patent application, a shredder comprises a housing, a shredder mechanism, a motor, and a lubricant system. The shredder mechanism comprises a first rotatable shaft having a first plurality of cutter blades fixedly mounted thereon, a first plurality of strippers mounted adjacent the first rotatable shaft with each of the strippers arranged between a corresponding pair of the first cutter blades on the first rotatable shaft, a second rotatable shaft having a second plurality of cutter blades fixedly mounted thereon, and a second plurality of strippers mounted adjacent the second rotatable shaft with each of the strippers arranged between a corresponding pair of the second cutter blades on the second rotatable shaft. Each of the strippers of the first plurality of strippers comprises a first lubricant tubing opening formed therethrough. The first lubricant tubing openings are radially offset from the first plurality of strippers and aligned with one another to form a first lubricant tubing passage through the first plurality of strippers. Each of the strippers of the second plurality of strippers comprises a second lubricant tubing opening formed therethrough. The second lubricant tubing openings are radially offset from the second plurality of strippers and aligned with one another to form a second lubricant tubing passage through the second plurality of strippers. The first and second rotatable shafts are arranged parallel to one another with the cutter blades on each rotatable shaft axially interleaved with the cutter blades of the other. The motor is coupled to the shredder mechanism for rotating the rotatable shafts in counter-rotating directions to shred articles between the first and second pluralities of cutter blades. The lubricant system comprises a lubricant reservoir, lubricant delivery tubing, and a lubricant pump. The lubricant reservoir is configured for containing a supply of liquid lubricant. The lubricant delivery tubing is communicated in a closed loop to the lubricant reservoir and routed through both the first and second lubricant tubing passages. The closed loop is configured to enable the lubricant to flow from the lubricant reservoir, through the lubricant delivery tubing and back to the lubricant reservoir. The lubricant delivery tubing is configured to be permeable to the liquid lubricant through a surface thereof along portions disposed within the first and second lubricant tubing passages for delivering a portion of the liquid lubricant flowing therethrough to lubricate the strippers and the cutter blades. The lubricant pump is configured for pumping the lubricant from the lubricant reservoir through the lubricant delivery tubing.

Implementations of the foregoing aspects may include one or more of the following features.

In an aspect, the lubricant delivery tubing may be a single lubricant delivery tube routed in one direction through the first lubricant tubing passage and then back in an opposite direction through the second lubricant tubing passage with a bight portion extending between the first and second lubricant tubing passages. The single lubricant delivery tube may have its opposing ends communicated to the lubricant reservoir to establish the closed loop.

In an aspect, the lubricant delivery tubing may be provided with a plurality of perforations through the surface thereof along the portions disposed within the first and second lubricant tubing passages to be permeable to the liquid lubricant.

In an aspect, the perforations may be laser perforated.

In an aspect, the lubricant delivery tubing may comprise a first lubricant delivery tube and a second lubricant delivery tube. The first lubricant delivery tube may be routed through the first lubricant tubing passage and the second lubricant delivery tube may be routed through the second lubricant tubing passage. Each of the lubricant delivery tubes may have its opposing ends communicated to the lubricant reservoir to establish the closed loop.

In another embodiment of the present patent application, a shredder is provided. The shredder is configured to shred at least paper. The shredder comprises a housing, a shredder mechanism, a motor, and a lubricant system. The shredder mechanism comprises a first rotatable shaft having a first plurality of cutter blades fixedly mounted thereon, a first plurality of strippers mounted adjacent first rotatable shaft with each of the first plurality of strippers arranged between a corresponding pair of the cutter blades on the first rotatable shaft; and a second rotatable shaft having a second plurality of cutter blades fixedly mounted thereon, a second plurality of strippers mounted adjacent second rotatable shaft with each of the second plurality of strippers arranged between a corresponding pair of the cutter blades on the second rotatable shaft. The first and second rotatable shafts are arranged parallel to one another with the cutter blades on each rotatable shaft axially interleaved with the cutter blades of the other. The motor is coupled to the shredder mechanism for rotating the rotatable shafts in counter-rotating directions to shred at least paper between the first and second pluralities of cutter blades. The lubricant system comprises a lubricant reservoir, one or more lubricant delivery conduits, and a lubricant pump. The lubricant reservoir is configured for containing a supply of liquid lubricant. The one or more lubricant delivery conduits is communicated to the lubricant reservoir for delivering a portion of the liquid lubricant flowing therethrough to lubricate the strippers and cutter blades. The lubricant pump is configured for pumping the lubricant from the lubricant reservoir through the one or more lubricant delivery conduits. The strippers of the first and second pluralities comprise strippers having a paper retention opening formed therein. Each paper retention opening faces axially for capturing paper particles therein from the paper shredded between the first and second pluralities of cutter blades to enable the captured paper particles to collect the lubricant therein.

Implementations of the foregoing aspects may include one or more of the following features.

In an aspect, each paper retention opening may be aligned at least partially with the first or second pluralities of blades such that at least one adjacent blade at least partially overlaps the paper retention opening for contact with the paper particles with collected lubricant when captured therein.

In an aspect, each paper retention opening may be formed through a thickness of its stripper and the at least one adjacent blade at least partially overlapping the paper retention opening is a pair of adjacent blades at least partially overlapping the paper retention opening on opposing axial sides thereof.

In an aspect, each paper retention opening may have the pair of adjacent blades partially overlapping the paper retention opening on opposing axial sides thereof.

In an aspect, the blades of the first and second pluralities may be cross-cut blades with circumferentially extending edges for longitudinally cutting the paper and radially projecting cutting edges for cross-cutting the paper.

In an aspect, each paper retention opening may have the pair of adjacent blades partially overlapping the paper retention opening on opposing axial sides thereof.

In an aspect, the blades of the first and second pluralities may be cross-cut blades with circumferentially extending edges for longitudinally cutting the paper and radially projecting cutting edges for cross-cutting the paper.

In yet another embodiment of the present patent application, a shredder is provided. The shredder is configured to shred at least paper. The shredder comprises a housing; a shredder mechanism, and a motor. The shredder mechanism comprises a first rotatable shaft having a first plurality of cutter blades fixedly mounted thereon, a first plurality of strippers mounted adjacent the first shaft with each of the strippers arranged between a corresponding pair of the cutter blades on the first shaft, a second rotatable shaft having a second plurality of cutter blades fixedly mounted thereon, and a second plurality of strippers mounted adjacent the second shaft with each of the strippers arranged between a corresponding pair of the cutter blades on the second shaft. Each of the strippers of the first plurality have a first anvil portion. Each of the strippers of the second plurality have a second anvil portion. The first and second shafts are arranged parallel to one another with the cutter blades on each shaft axially interleaved with the blades of the other. The motor is coupled to the shredder mechanism for rotating the shafts in counter-rotating directions to shred the at least paper between the first and second pluralities of cutter blades, The first anvil portion of each of the strippers of the first plurality is configured to support the at least paper laterally while each of the cutter blades of the second plurality penetrates the at least paper. The second anvil portion of each of the strippers of the second plurality is configured to support the at least paper laterally while each of the cutter blades of the first plurality penetrates the at least paper.

Implementations of the foregoing aspects may include one or more of the following features.

In an aspect, each of the strippers of the first plurality may be configured to be stationary with respect to the first rotatable shaft. Each of the strippers of the second plurality may be configured to be stationary with respect to the second rotatable shaft.

In an aspect, each of the first anvil portion and the second anvil portion may have a non-elongated shaped configuration.

In an aspect, the first anvil portion may have a first projection that is either angled or convex shaped so that the cutter blades of the second plurality that are adjacent the first anvil portion are configured to pierce the at least paper near the first projection. The second anvil portion has a second projection that is either angled or convex shaped so that the cutter blades of the first plurality that are adjacent the second anvil portion are configured to pierce the at least paper near the second projection.

In an aspect, each of the strippers of the first plurality may include a first paper restrictor portion and a first relief portion. The first relief portion may be positioned between the first paper restrictor portion and the first anvil portion. Each of the strippers of the second plurality may include a second paper restrictor portion and a second relief portion. The second relief portion may be positioned between the second paper restrictor portion and the second anvil portion.

In an aspect, the first paper restrictor portion of one of the strippers of the first plurality and the second paper restrictor portion of an adjacent one of the strippers of the second plurality may be configured to form a paper receiving opening. The first relief portion of one of the strippers of the first plurality and the second relief portion of an adjacent one of the strippers of the second plurality may be configured to form a relief space. The relief space may be configured to be wider than the paper receiving opening and the relief space is configured to reduce jamming of the at least paper due to a paper wrinkle or a paper fold.

In an aspect, the first projection and the paper receiving opening may be configured to create tension on the at least paper as the at least paper passes through the first projection and the paper receiving opening. The second projection and the second paper restrictor portion may be configured to create tension on the at least paper as the at least paper passes through the second projection and the paper receiving opening.

In an aspect, the first projection and the first paper restrictor portion may be configured to create tension on the at least paper as the at least paper passes through the first projection and the paper receiving opening. The second projection and the second paper restrictor portion may be configured to create tension on the at least paper as the at least paper passes through the second projection and the paper receiving opening.

In an aspect, the paper receiving opening may be configured to limit the number or thickness of the at least paper received by the shredder mechanism.

In an aspect, the relief space may have a substantially oval shaped configuration.

These and other aspects of the present patent application, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise. It should also be appreciated that some of the components and features discussed herein may be discussed in connection with only one (singular) of such components, and that additional like components which may be disclosed herein may not be discussed in detail for the sake of reducing redundancy.

Other aspects, features, and advantages of the present patent application will become apparent from the following detailed description, the accompanying drawings, and the appended claims.

### BRIEF DESCRIPTION OF THE DRAWINGS

Various embodiments are disclosed, by way of example only, with reference to the accompanying schematic drawings in which corresponding reference symbols indicate corresponding parts, in which

FIG. 1 shows a partially exploded view of an exemplary shredder in accordance with an embodiment of the present patent application;

FIG. 2 shows a cabinet assembly, a bin assembly and a door assembly of the shredder in accordance with an embodiment of the present patent application;

FIG. 3 shows the door assembly of the shredder in accordance with an embodiment of the present patent application;

FIG. 4 shows an inner door panel and elastic bands of the door assembly of FIG. 3;

FIG. 5 shows the bin assembly of the shredder in accordance with an embodiment of the present patent application;

FIG. 6 shows the cabinet assembly of the shredder in accordance with an embodiment of the present patent application;

FIG. 7 shows a top housing assembly, including a CD flap subassembly, of the shredder in accordance with an embodiment of the present patent application;

FIG. 8 shows the CD flap subassembly of the top housing assembly of FIG. 7;

FIG. 9 shows an oil tank/reservoir assembly, including an oil cap assembly, of the shredder in accordance with an embodiment of the present patent application;

FIG. 10 shows the oil cap assembly of the oil tank assembly of FIG. 9;

FIG. 11 shows an assembled configuration of a cutting block assembly/shredder mechanism and a motor assembly, including a motor and a gearbox assembly, of the shredder in accordance with an embodiment of the present patent application;

FIG. 12 shows a partially exploded configuration of the cutting block assembly and the motor assembly of FIG. 11;

FIG. 13 shows a partially exploded view of the motor assembly of the shredder in accordance with an embodiment of the present patent application;

FIG. 14 shows a partially exploded view of the cutting block assembly of the shredder with some portions of the motor assembly in accordance with an embodiment of the present patent application;

FIG. 15 shows a top elevation view of the cutting block assembly of the shredder with some portions of the motor assembly in accordance with an embodiment of the present patent application;

FIG. 16 shows a perspective view of the cutting block assembly of the shredder with some portions of the motor assembly in accordance with an embodiment of the present patent application;

FIG. 17 shows a front view of the cutting block assembly of the shredder with some portions of the motor assembly and a cross-sectional view, taken along a line A-A, of the cutting block assembly with some portions of the motor assembly of the shredder in accordance with an embodiment of the present patent application;

FIG. 18 shows a front view of the cutting block assembly of the shredder with some portions of the motor assembly and a detailed view of portions of the cutting block assembly of the shredder in accordance with an embodiment of the present patent application;

FIG. 19 shows an exploded view of a (left) bearing plate assembly of the cutting block assembly of the shredder in accordance with an embodiment of the present patent application;

FIG. 20 shows an assembled view of a (right) bearing plate assembly of the cutting block assembly of the shredder in accordance with an embodiment of the present patent application;

FIG. 21 shows a front and a perspective views of a stripper of the shredder in accordance with an embodiment of the present patent application;

FIG. 22 shows one of a first or second rotatable shaft with a first or second plurality of cutter blades, a first or second plurality of strippers, and a first or second plurality of spacers mounted on the first or second rotatable shaft of the shredder in accordance with an embodiment of the present patent application;

FIG. 23 shows the other of the first or second rotatable shaft with the first or second plurality of cutter blades, the first or second plurality of strippers, and the first or second plurality of spacers mounted on the first or second rotatable shaft of the shredder in accordance with an embodiment of the present patent application;

FIG. 24 shows a cross-sectional view of the cutting block assembly of the shredder in accordance with another embodiment of the present patent application;

FIG. 25 shows a perspective view of the cutting block assembly of the shredder in accordance with another embodiment of the present patent application, where some portions of the cutting block assembly are not shown to clearly show other portions of the cutting block assembly;

FIG. 26 shows the first and second rotatable shafts being connected/coupled to the bearing plate assembly in accordance with an embodiment of the present patent application, wherein a spacer stacked on the (left) rotatable shaft and a cutter blade stacked on the (right) rotatable shaft are shown;

FIG. 27 shows two cutter blades and their index marks in accordance with an embodiment of the present patent application, wherein the index features/marks of the (left and right) cutter blades are aligned as shown here when the two cutter blades are mounted on the first and second rotatable shafts, respectively;

FIG. 28 shows the first and second rotatable shafts being connected/coupled to the bearing plate assembly in accordance with an embodiment of the present patent application, wherein the index mark of the (right) cutter blade being aligned with an index groove of the (right) rotatable shaft;

FIG. 29 shows the first and second rotatable shafts being connected/coupled to the bearing plate assembly in accordance with an embodiment of the present patent application, wherein three layers are stacked on each of the first and second rotatable shafts (e.g., (1) a spacer, (2) a cutter blade, and (3) a spacer nested together with a stripper stacked on the (left) rotatable shaft, and (1) a cutter blade, (2) a spacer nested together with a stripper, and (3) a cutter blade stacked on the (right) rotatable shaft);

FIGS. 30-32 show the first and second rotatable shafts being connected/coupled to the bearing plate assembly in accordance with an embodiment of the present patent application, wherein multiple layers of strippers, spacers and cutter blades are stacked on or being stacked on the first and second rotatable shafts, wherein FIG. 32 also shows the stacking order of the strippers, spacers and cutter blades and FIGS. 31 and 32 also show stripper shafts;

FIG. 33 shows the first and the second rotatable shafts being connected/coupled to the bearing plate assembly in accordance with an embodiment of the present patent application, wherein a stripper is omitted in a first layer (and a last layer) being stacked on the first and the second rotatable shafts (e.g., the first layer may include a spacer stacked on the (left) rotatable shaft and a cutter blade stacked on the (right) rotatable shaft);

FIG. 34 shows the first and second rotatable shafts being connected/coupled to the bearing plate assembly in accordance with an embodiment of the present patent application, wherein tips of the cutter blade that is stacked on the (right) rotatable shaft point to the top of the stripper (not shown) that will be stacked on the (left) rotatable shaft;

FIG. 35 shows another partially exploded view of the cutter block assembly of the shredder in accordance with an embodiment of the present patent application;

FIG. 36 shows a front view and a perspective view of a bin full assembly of the shredder in accordance with an embodiment of the present patent application;

FIG. 37 shows another perspective view of a bin full assembly of the shredder in accordance with an embodiment of the present patent application; and

FIG. 38 shows a door interlock switch assembly for the door assembly (shown in FIGS. 2-4) of the of the shredder in accordance with an embodiment of the present patent application.

### DETAILED DESCRIPTION OF THE DRAWINGS

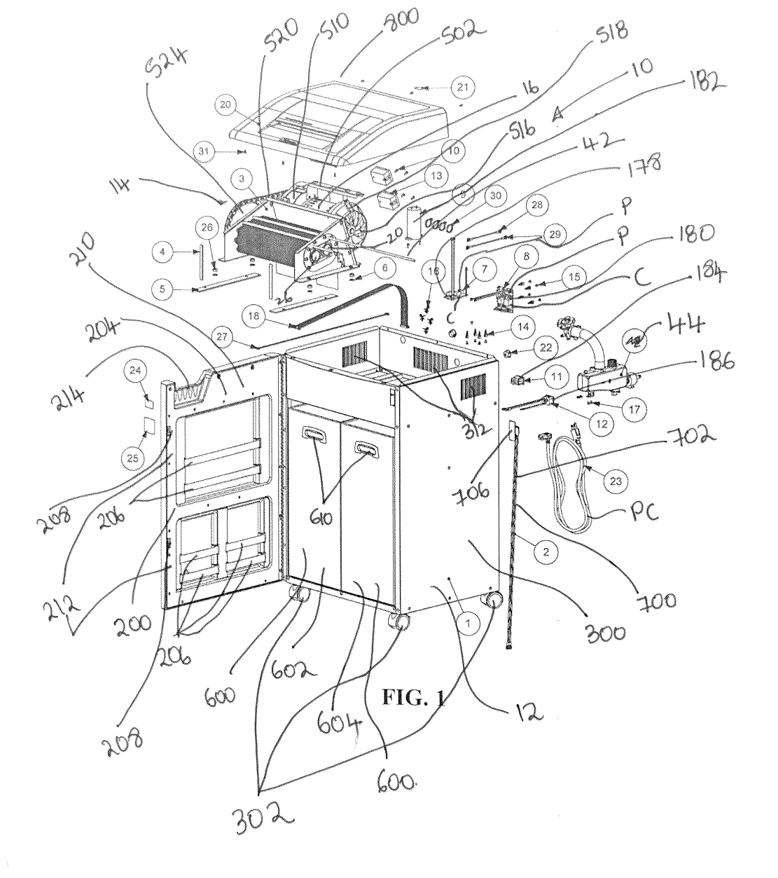

FIG. 1 shows a shredder 10 that comprises a housing 12, a shredder mechanism 14, a motor 16, and a lubricant system 18. The shredder mechanism 14 comprises a first rotatable shaft 20 having a first plurality of cutter blades 22 fixedly mounted thereon, a first plurality of strippers 24 mounted adjacent the first rotatable shaft 20 with each of the strippers 24 arranged between a corresponding pair of the first cutter blades 22 on the first rotatable shaft 20, a second rotatable shaft 26 having a second plurality of cutter blades 28 fixedly mounted thereon, and a second plurality of strippers 30 mounted adjacent the second rotatable shaft 26 with each of the strippers 30 arranged between a corresponding pair of the second cutter blades 28 on the second rotatable shaft 26. Each of the first plurality of strippers 24 comprises a first lubricant tubing opening 32 formed therethrough. The first lubricant tubing openings 32 are radially offset from the first plurality of strippers 24 and aligned with one another to form a first lubricant tubing passage 34 through the first plurality of strippers 24. Each of the second plurality of strippers 30 comprises a second lubricant tubing opening 36 formed therethrough. The second lubricant tubing openings 34 are radially offset from the second plurality of strippers 30 and aligned with one another to form a second lubricant tubing passage 38 through the second plurality of strippers 30.

The first and the second rotatable shafts 20, 26 are arranged parallel to one another with the cutter blades 22, 28 on each rotatable shaft 20, 26 axially interleaved with the cutter blades 22, 28 of the other 20, 26. The motor 16 is coupled to the shredder mechanism 14 for rotating the rotatable shafts 20, 26 in counter-rotating directions to shred articles/papers between the first and second pluralities of cutter blades 22, 28.

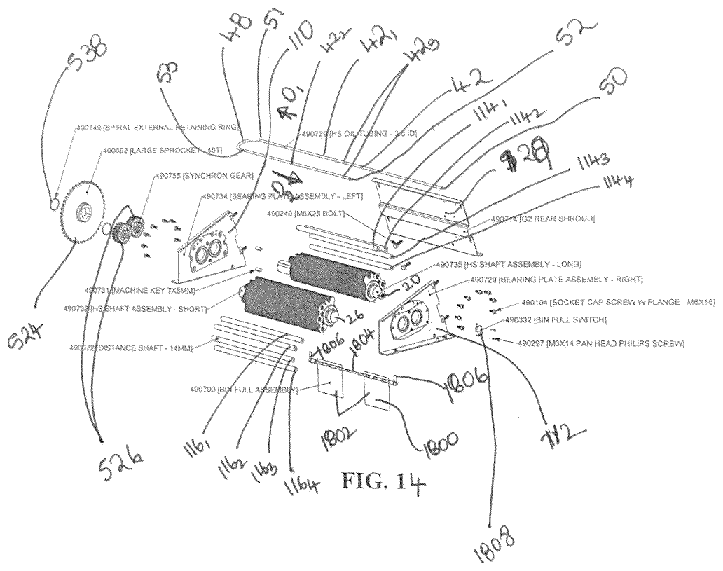

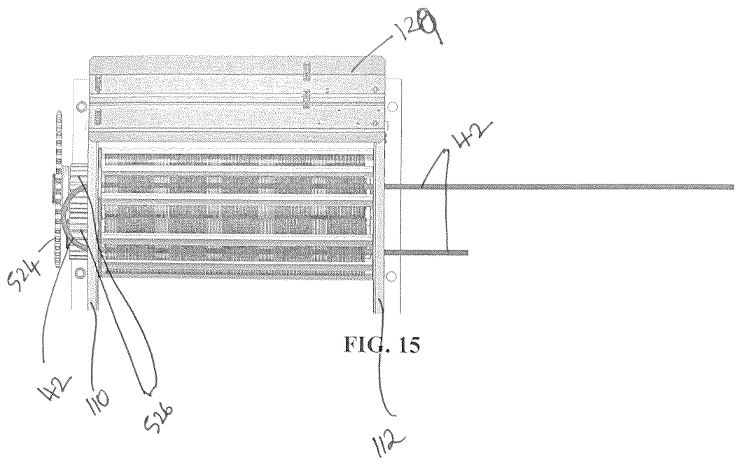

The lubricant system 18 comprises a lubricant reservoir 40, lubricant delivery tubing 42, and a lubricant pump 44. The lubricant reservoir 40 is configured for containing a supply of liquid lubricant. In the illustrated embodiment, the lubricant delivery tubing 42 is communicated in a closed loop to the lubricant reservoir 40 and routed through both the first and second lubricant tubing passages 34, 38. As discussed in detail below, the lubricant delivery tubing 42 may include a single lubricant circuit (that starts at the lubricant reservoir 40, routed through both the first and second lubricant tubing passages 34, 38, and ends at the lubricant reservoir 40) or may include two lubricant circuits (each start at the lubricant reservoir 40, routed through one of the first and second lubricant tubing passages 34, 38, and end at the lubricant reservoir 40). Any number of lubricant circuits may be used. The closed loop is configured to enable the lubricant to flow from the lubricant reservoir 40, through the lubricant delivery tubing 42 and back to the lubricant reservoir 40. The lubricant delivery tubing 42 is configured to be permeable to the liquid lubricant through a surface 46 thereof along portions 56 disposed within the first and second lubricant tubing passages 34, 38 for delivering a portion of the liquid lubricant flowing therethrough to lubricate the strippers 24, 30 and the cutter blades 22, 28. The lubricant pump 44 is configured for pumping the lubricant from the lubricant reservoir 40 through the lubricant delivery tubing 42 (or through the one or more lubricant delivery conduits 42₁ and 42₂ as shown in and described with respect to FIG. 14).

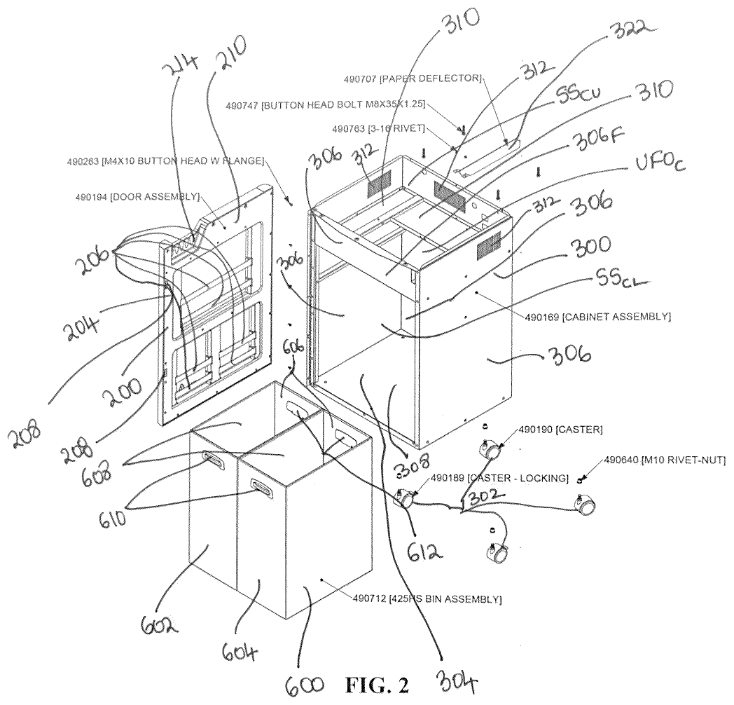

FIG. 2 shows a cabinet assembly 300, a bin assembly 600 and a door assembly 200 of the shredder 10. The shredder 10 may include the freestanding housing 12. The housing 12 may include the cabinet assembly 300, the door assembly 200 and other housing portions (e.g., a top housing assembly 800). The bin assembly 600 may be enclosed in the housing 12 (including the cabinet assembly 300 and the door assembly 200). The door assembly 200 (e.g., an access door) of the shredder 10 may be provided for access to and removal of the bin assembly 600 from the cabinet assembly 300.

Referring to FIGS. 1-2 and 6, the cabinet assembly 300 may include a bottom wall 304 and four side walls 306 to define an upper storage space SS_{CU}, a lower storage space SS_{CL} and an upwardly facing opening UFO_{C} that extends through both the upper storage space SS_{CU} and the lower storage space SS_{CL}. The cabinet assembly 300 may be made of a plastic material or any other material. The cabinet assembly 300 may also include wall portions 310 that are configured to partially separate the upper storage space SS_{CU} and the lower storage space SS_{CL} of the cabinet assembly 300. The wall portions 310 may be configured to support portions of the shredder mechanism 14 thereon. One of the side walls 306; may include an access opening 308 that is configured to enable the bin assembly 600 to be received in the lower storage space SS_{CL}. The bottom wall 304 may be configured to support the bin assembly 600 thereon. The shredder mechanism 14 may be received in the upper storage space SS_{CU}. The shredded documents from the shredder mechanism 14 may pass through the upwardly facing opening UFO_{C} into the bin assembly 600 disposed in the lower storage space SS_{CL}. The walls of the cabinet assembly 300 surrounding the upper storage space SS_{CU} may include one or more vents 312 configured for releasing heated air from a motor assembly MA and the shredder mechanism 14 therethrough. The vents 312 may be used in cooperation with the shredder mechanism 14 and the motor assembly MA.

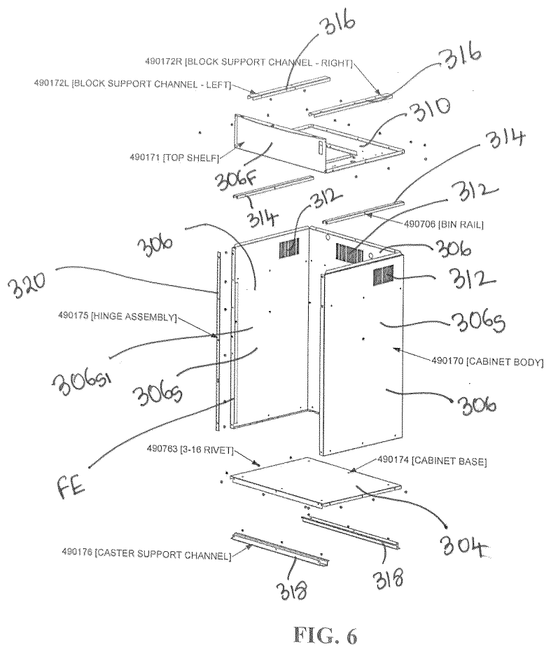

Referring to FIG. 6, the cabinet assembly 300 may include bin rails 314 disposed on the side walls 306_{S}. The bin assembly 600 may be mounted on the bin rails 314. The bin rails 314 may be slide rails (two are being shown in FIG. 6, for example, left and right slide rails) so that the bin assembly 600 may be slid or moved along with the bin rails 314. The side wall 306_{F} and the wall portions 310 may be integrally formed and may be referred to as a top shelf. The cabinet assembly 300 may include two support channels 316 (two are being shown in FIG. 6, for example, left and right support channels) that are configured to support the shredder mechanism 14 when the shredder mechanism 14 is disposed in the upper storage space SS_{CU}.

As shown in FIGS. 1-2, the shredder 10 may be transported from one place to another by simply rolling the housing 12 on roller members 302, such as wheels or casters. The housing 12 may include two pairs of roller members 302 attached to the bottom of the cabinet assembly 300 to support the housing 12. The rolling members 302 can be located on the cabinet assembly 300 as near the bottom corners as practical. The roller members 302 may be locked against rolling motion by lock members to provide a stationary configuration. The front pair of the roller members 302 may be in the form of casters that provide a turning capability to the housing 12, while the rear pair of the roller members 302 may be in the form of wheels that are fixed in direction, so as to only allow roll in the intended direction of travel. The front and rear pair of the roller members 302 may in the form of casters.

Referring to FIG. 6, the cabinet assembly 300 may also include two wheel/caster support channels 318 that are connected to a bottom/under surface of the bottom wall 304, one in a rear portion of the bottom wall 304 and the other in a front portion of the bottom wall 304. The wheel/caster support channels 318 may be configured to support roller members 302.

As shown in FIG. 6, the cabinet assembly 300 may also include a hinge assembly 320 that is connected to a front edge FE of the side wall 306_{S1}. The hinge assembly 320 may be configured to connect the door assembly 200 to the cabinet assembly 300.

The door assembly 200 may be configured to be pivotably movable with respect to the cabinet assembly 300 between an open position in which access to and removal of the bin assembly 600 from the cabinet assembly 300 may be provided and a closed position in which an access opening 308 of the cabinet assembly 300 is covered.

Referring to FIG. 2, the shredder 10 may include a paper deflector (or deflector) 322. The deflector or paper deflector 322 may include a paper deflecting surface provided above the shredder mechanism 14 that is configured to deflect and direct paper/article grasped fed by a (movable) feed mechanism into the shredder mechanism 14. The deflector 322 may be designed such that the deflector 322 at least partially surrounds or at least is positioned adjacent the feed mechanism in the shredder 10, while still providing clearance for its rotation. The deflector 322 may be used to ensure direction and feeding of the picked or separated articles or paper sheet(s) into the cutter blades 22, 28 of the shredder mechanism 14.

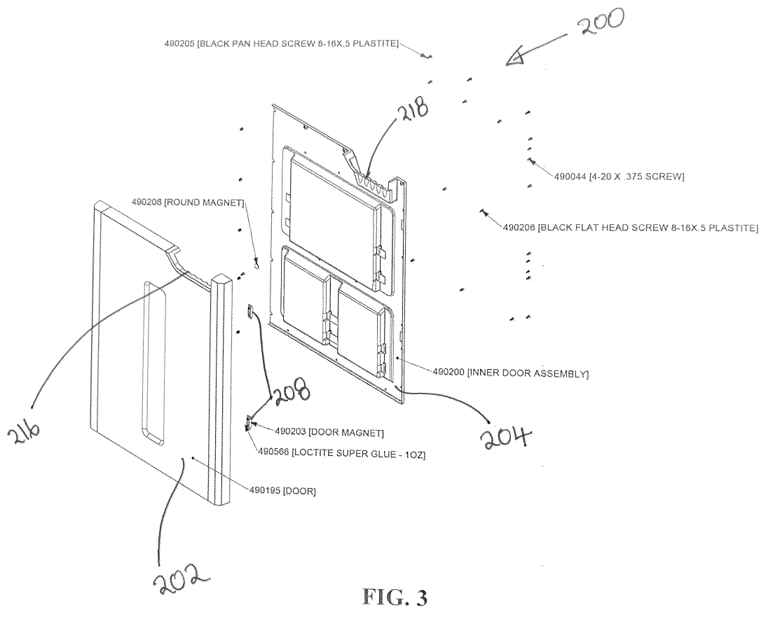

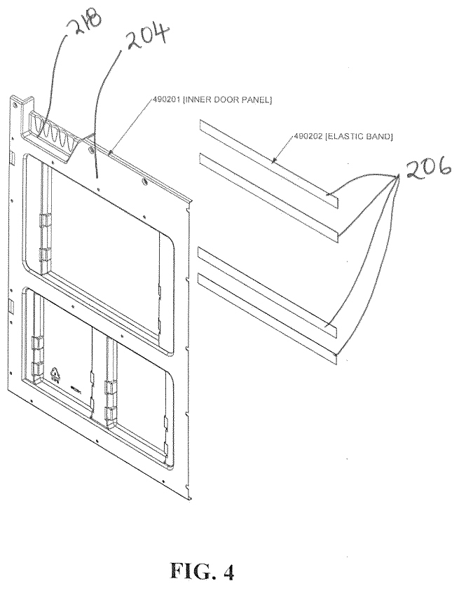

FIG. 3 shows the door assembly 200 of the shredder 10 and FIG. 4 shows an inner door panel/member 204 of the door assembly 200.

Referring to FIGS. 1-4, the door assembly 200 may be configured to allow access to or to cover the access opening 308 of the cabinet assembly 300. The hinge 320 may be configured to pivotally connect the door assembly 200 to the cabinet assembly 300 for movement between a closed position and an open position. In the open position, the door assembly 200 may be positioned perpendicular to the side wall 306_{F} of the cabinet assembly 200 to provide access to the access opening 308 of the cabinet assembly 300 (e.g., for removal of the bin assembly 600 from the cabinet assembly 300). In the closed position, the door assembly 200 may be positioned parallel to the side wall 306_{F} of the cabinet assembly 200 such that the door assembly 200 may form a secure barrier preventing unauthorized entry into the lower interior storage space SS_{CL} of the cabinet assembly 300 in which the bin assembly 600 is disposed.

The door assembly 200 may include an outer door panel/member 202, the inner door member 204, a plurality of door magnets 208 and a plurality of elastic members/bands 206. The door assembly 200 may be made of plastic material or any other material. The inner and outer door panel configuration may provide a more finished look for the door assembly 200. The inner door panel 204 may be configured to add an additional structural element to the door assembly 200. The inner door panel 204 may be configured to allow for storage of operating instructions, of additional oil bottles to add to the reservoir, etc.

The plurality of door magnets 208 may be positioned on a surface 210 of the inner door member 204 and may be configured to lock the door assembly 200 to the cabinet assembly 300 when the door assembly 200 is in the closed position. The plurality of door magnets 208 may be positioned along edge portions 212 (in an upper portion and a lower portion) of the inner door member 204. The door assembly 200 may also include additional locks. The plurality of elastic members/bands 206 may be positioned/disposed on the surface 210 of the inner door member 204.

The outer door member 202 and the inner door member 204 may have aligned handle portions 216, 218 that together form an integral door handle 214 that may be disposed on the top right hand side corner portions of the door assembly 200 and may be configured to aid in opening the door assembly 200 from its closed position to its open position.

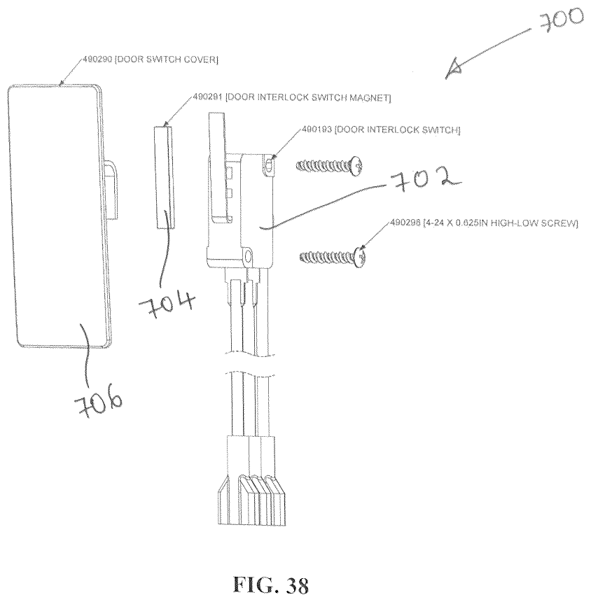

Referring to FIGS. 1 and 38, the shredder 10 may include a door interlock switch assembly 700. The door interlock switch assembly 700 may be connected/coupled to the housing 12/the cabinet assembly 300 and/or portions of the door assembly 200. The door interlock switch assembly 700 may include a door interlock switch 702, a door interlock switch magnet 704 and a door switch cover 706. The door interlock switch assembly 700 may be configured to detect whether the door assembly 200 is closed and/or locked during the operation of the shredder 10. A signal from the door interlock switch may be sent to a controller C, which in turn may be configured to control the motor 16 based on the received signal. For example, when a signal from the door interlock switch assembly 700 (sent to the controller C) indicates that the door assembly 200 is not closed and/or not locked, the controller C may be configured to stop the operation of the motor 16. That is, when the door interlock switch assembly 700 detects that the door assembly 200 has been opened during the operation of the shredder 10, the operation of the shredder mechanism 14 of the shredder 10 is immediately stopped (e.g., by cutting off/stopping the power supply to the motor 16). The controller C may be configured to light up a door open icon on the control panel when the door is open.

As shown in FIGS. 1-2 and 5, the bin assembly 600 may be disposed in the cabinet assembly 300. The bin assembly 600 may be enclosed in the housing 12. The bin assembly 600 may be surrounded by the cabinet assembly 300 and the door assembly 200 on the bottom and the sides of the bin assembly 600. The shredder mechanism 14 may be designed for use with the housing 12, including the cabinet assembly 300 and the bin assembly 600, as the shredder mechanism 14 is disposed on an upper portion of the cabinet assembly 300 and as the shredder mechanism 14 is disposed above the bin assembly 600. That is, the bin assembly 600 may be positioned under the shredder mechanism 14. The bin assembly 600 may be configured to receive shredded documents from the shredder mechanism 14. The bin assembly 600 may be configured to be manually removable from beneath the shredder mechanism 14 and from the cabinet assembly 300, using handles 610, 612, for emptying of the shredded documents in the bin assembly 600.

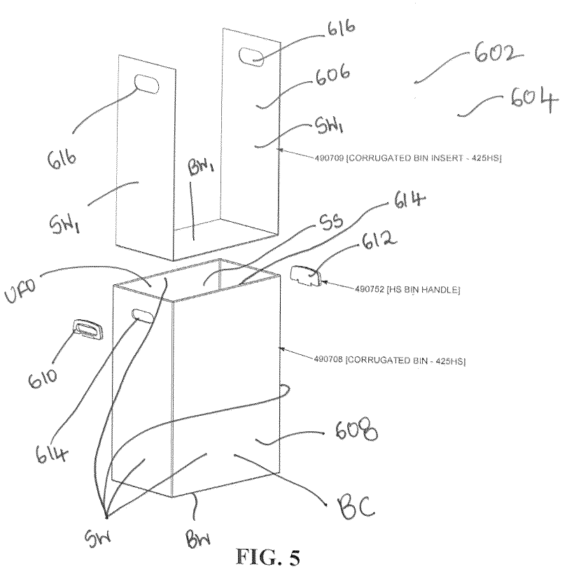

The bin assembly 600 may include two bins 602, 604. Due to large waste particle weight, two waste bins 602, 604 may be used. The number of bins may vary. The bin assembly 600 may include one bin or four bins. FIG. 5 shows one of two bins 602, 604 of the bin assembly 600. Each bin 602, 604 includes a bin insert 606, a bin/container 608, and the at least two bin handles 610, 612. The container 608 may include a base container BC having a storage space SS and defining an upwardly facing opening UFO into the storage space SS. The container 608 may include a bottom wall BW and side walls SW (e.g., four side walls) defining the storage space SS. The container 608 may include openings 614 on side walls SW. The openings 614 may be configured to align with openings 616 of the bin insert 606. The aligned openings 614, 616 of the container 608 and the bin insert 606 may be configured to receive portions of the handles 610, 612. The bin insert 606 may include a bottom wall BW₁ and side walls SW₁ (e.g., two side walls). The bin insert 606 may be configured to be received in the storage space SS of the container 608. The bin insert 606 may be configured to reinforce the side walls SW and the bottom wall BW of the container 608. After the bin insert 606 is inserted into the container 608, the upwardly facing opening UFO of the container 608 may be configured to receive the shredded documents from the shredder mechanism 14 into the storage space SS of the container 608. That is, the upwardly facing opening UFO of the container 608 may be configured such that the shredder mechanism 14 discharges shredded articles into the container 608 through the upwardly facing opening UFO. As noted above, the handles 610, 612 may facilitate emptying of the shredded documents in the bin assembly 600. The bin insert 606 and the container 608 may be made of corrugated material. The bin insert 606 and the container 608 may be made of molded plastic or any other material.

The shredder 10 may include a sensor that is configured to detect if the bin assembly 600 is not received in the cabinet assembly 300 and is not correctly/properly positioned in the cabinet assembly 300 before beginning/starting the operation of the shredder 10. This sensor may be disposed on the housing 12/the cabinet assembly 300 and/or portions of the bin assembly 600. The signals from this sensor may be configured to be sent to the controller C, which in turn may be configured to control the motor 16 based on the received signal. For example, when a signal from the sensor (sent to the controller C) indicates that the bin assembly 600 is not received in the cabinet assembly 300 and/or the bin assembly 600 is not correctly/properly positioned in the cabinet assembly 300, the controller C may be configured to stop power delivery/supply to the motor 16. The controller C may also be configured to provide an indication to a user about missing bin assembly 600 and/or improper placement of the bin assembly 600 in the cabinet assembly 300.

Referring to FIGS. 1 and 7-8, the housing 12 may also include a top housing assembly 800. The top housing assembly 800 may be made of plastic or any other material.

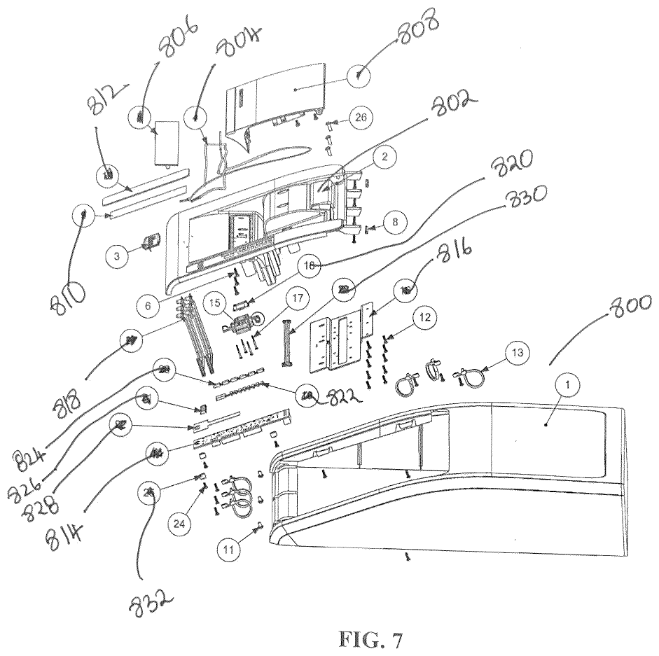

Referring to FIG. 7, the top housing assembly 800 may include a top throat insert 802, a wire assembly 804, an insert 806, a CD flap subassembly 808, a control panel 810, a display panel 812, a control panel Printed Circuit Board (PCB) 814 (e.g., the control panel PCB 814 may be part of the controller C), a top shroud 816, a pair of auto-start sensors 818, and a bracket 820. The top housing assembly 800 may also include a lens insert 822 for JPS, a lens insert 824 for icons, a lens insert 826 for power, a JPS wire assembly 830, a support cap 832 for the control panel PCB 814, and a double sided tape 828 for the control panel PCB 814. The shredder may include a low oil indicator (e.g., LED) and an oiling indicator when the pump is active. The wire assembly 804 is a safe sense antenna wiring.

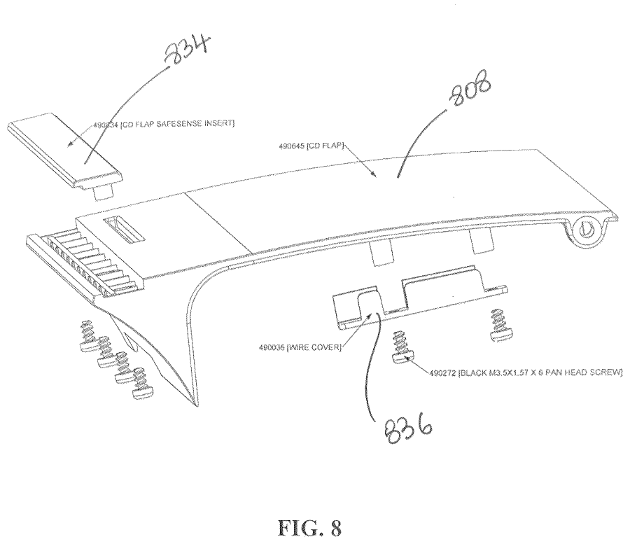

Referring to FIGS. 7 and 8, the CD flap subassembly 808 may include a CD flap insert 834 and a wire cover 836.

The top wall of the housing 12 may have a generally laterally extending opening extending generally parallel and above the cutter elements/blades 22, 28. The opening often may be referred to as a throat, enables the articles/papers being shredded to be fed into the cutter elements/blades 22, 28. As can be appreciated, the opening may be relatively narrow, which is desirable for preventing overly thick items, such as large stacks of documents, from being fed into cutter elements/blades 22, 28, which could lead to jamming. The opening may have any configuration. The top wall of the housing 12 may be molded from plastic. The shredder housing 12 and its top wall may have any suitable construction or configuration.

The shredder 10 may have any suitable construction or configuration and the illustrated embodiment is not intended to be limiting in any way. In addition, the term “shredder” is not intended to be limited to devices that literally “shred” documents and articles, but is instead intended to cover any device that destroys documents and articles in a manner that leaves each document or article illegible and/or useless.

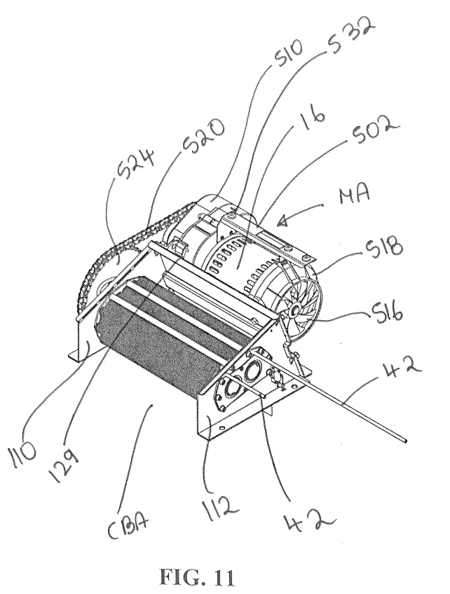

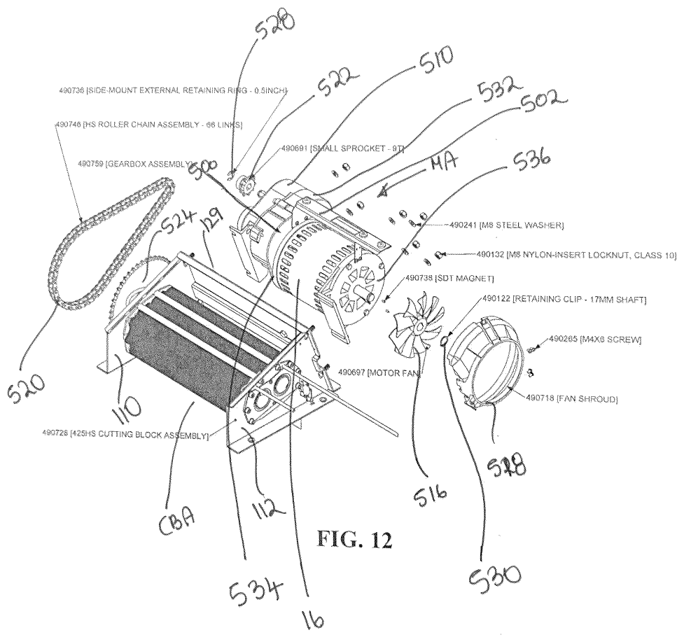

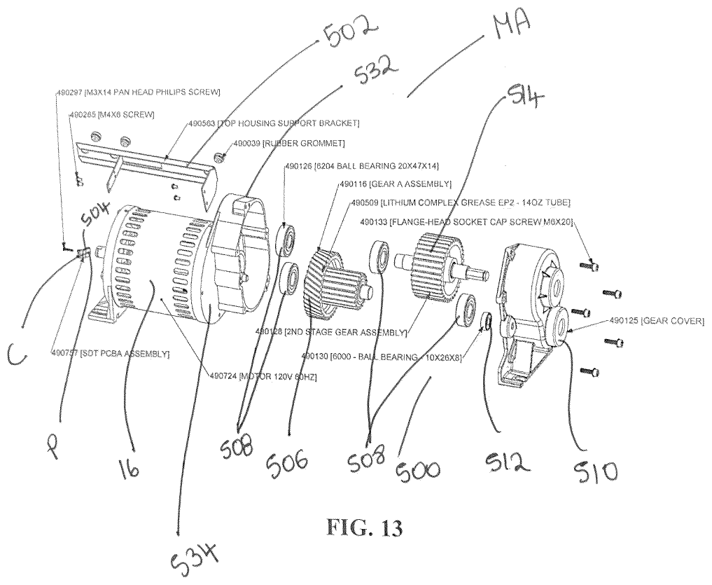

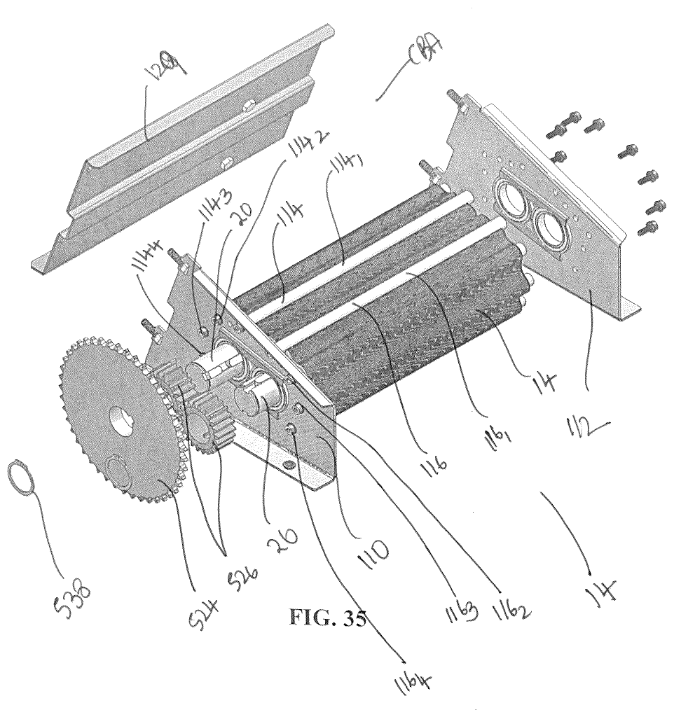

FIG. 11 shows an assembled configuration of the cutting block assembly CBA and the motor assembly MA of the shredder 10, while FIG. 12 shows a partially exploded configuration of the cutting block assembly CBA and the motor assembly MA. FIG. 13 shows a partially exploded view of the motor assembly MA of the shredder 10. FIGS. 14 and 35 show partially exploded views of the cutting block assembly CBA and some portions of the motor assembly MA of the shredder 10.

Referring to FIGS. 11-14, the motor assembly MA may include a top housing support bracket 502, the motor 16, a Printed Circuit Board Assembly (PCBA) 504 (e.g., may be part of the controller C), ball bearings 508 (e.g., four ball bearings each having a size of 20×4×14), ball bearing 512 (e.g., one ball bearing having a size of 10×26×8), a gear assembly 506, a second stage gear assembly 514, a gear cover 510, a motor fan 516, a fan shroud 518, a roller chain assembly 520, a small sprocket 522, a larger sprocket 524, synchron gears 526, a side mount external retaining ring 528, a retaining clip 530, and a spiral retaining ring 538.

The top housing support bracket 502 may be configured to connect/couple the motor 16 to portions of the housing 12. The transmission 500 (also referred to as a gearbox) may be configured to use the gears 506, 514 to change the speed or direction of rotation in the shredder 10. The gearbox assembly/transmission 500 may include the gear assembly 506, the second stage gear assembly 514, the ball bearings 508, and the ball bearing 512. The gear assembly 506, the second stage gear assembly 514, the ball bearings 508, and the ball bearing 512 are all enclosed between the gear cover 510 and the gear housing portion 532 on one side 534 of the motor 16. The motor 16 may be a 120 Volts (V) and 60 Hertz (Hz) motor. The motor 16 may be a bidirectional electric motor that is configured to rotate the rotating shaft 20 or 26 alternately in a first direction of rotation and a second direction of rotation responsive to the controller C. The motor 16 may be coupled to the shredder mechanism 14 for rotating the shafts 20, 26 in counter-rotating directions to shred the at least paper between the first and the second plurality of cutter blades 22, 28.

The motor fan 516 may be secured to and rotated by the shaft of the motor 16. The motor fan (or an external fan) may be configured to be accommodated in the fan shroud 518 that is mounted to a (rearward) end 536 of the motor 16. The retaining clip 530 may be configured to retain the motor fan 516 on the shaft of the motor 16. The motor 16 and the transmission 500 may be referred to as drive system. The drive system may have any number of motors and may include one or more transmissions.

The roller chain/track assembly 520 may include sixty six links. The sprockets may interchangeably be referred to as sprocket-wheels and the roller chain may interchangeably be referred to as track. The smaller sprocket 522 may be a sprocket 9T. The larger sprocket 524 may be a sprocket 45T. The side mount external retaining ring 528 may be configured to retain the small sprocket 522 at the output end of the transmission 500 and at one end of the roller chain 520. The spiral retaining ring 538 may be configured to retain the large sprocket 524 at the other end of the roller chain 520. The side mount external retaining ring 528 may be configured for 0.5 inches outer diameter shaft. The spiral retaining ring 538 may be configured for 35 millimeters outer diameter shaft. The details about the output/shaft of the motor 16 is being connected to input of the gears 506, 514, and the output of the gears 506, 514 is being connected to the rotatable shafts 20, 26 via the roller chain assembly 520, the small sprocket 522, the larger sprocket 524, and the synchron gears 526 are all well-known and will not be described herein in detail.

The shredder 10 includes the shredder mechanism 14 that includes the electrically powered motor 16 and the plurality of cutter elements/blades 22, 28. “Shredder mechanism” is a generic structural term to denote a device that destroys articles using at least one cutter blade 22, 28. Such destroying may be done in any particular way. For example, the shredder mechanism 14 may include at least one cutter blade 22, 28 that is configured to punch a plurality of holes in the document, paper or article in a manner that destroys the document, paper or article. The cutter blades 22, 28 may generally mounted be on the pair of parallel rotating/rotatable shafts 20, 26. The motor 16 may be configured to operate using electrical power (e.g., from a power cord PC as shown in FIG. 1) to rotatably drive the shafts 20, 26 and the cutter blades 22, 28 through the conventional transmission 500 (e.g., one such exemplary transmission is shown in and described in detail in FIGS. 11-14) so that the cutter blades 22, 28 shred articles fed therein. The shredder mechanism 14 may also include a sub-frame for mounting the rotatable shafts 20, 26, the motor 16, and the transmission 500. The operation and construction of such a shredder mechanism 14 are well known and need not be described herein in detail, except for the differences noted below. Generally, any suitable shredder mechanism 14 well-known in the art or developed hereafter may be used.

The shredder mechanism 14 may interchangeably referred to as cutter block or cutter block assembly. The shredder mechanism 14 may include the first rotatable shaft 20, the second rotatable shaft 26, the first plurality of cutter blades 22 fixedly mounted on the first rotatable shaft 20, the second plurality of cutter blades 28 fixedly mounted on the second rotatable shaft 26, the first plurality of strippers 24 mounted adjacent the first rotatable shaft 20 with each of the strippers 24 arranged between a corresponding pair of cutter blades 22 on the first rotatable shaft 20, and the second plurality of strippers 30 mounted adjacent the second rotatable shaft 26 with each of the strippers 30 arranged between a corresponding pair of cutter blades 28 on the second rotatable shaft 26. The first and second rotatable shafts 20, 26 may be arranged parallel to one another with the cutter blades 22, 28 on each rotatable shafts 20, 26 axially interleaved with the cutter blades 22, 28 of the other.

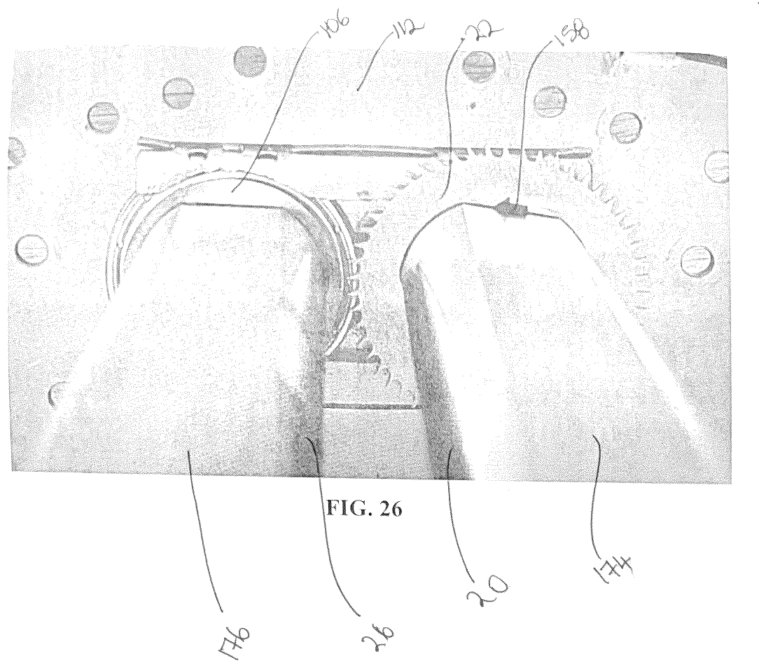

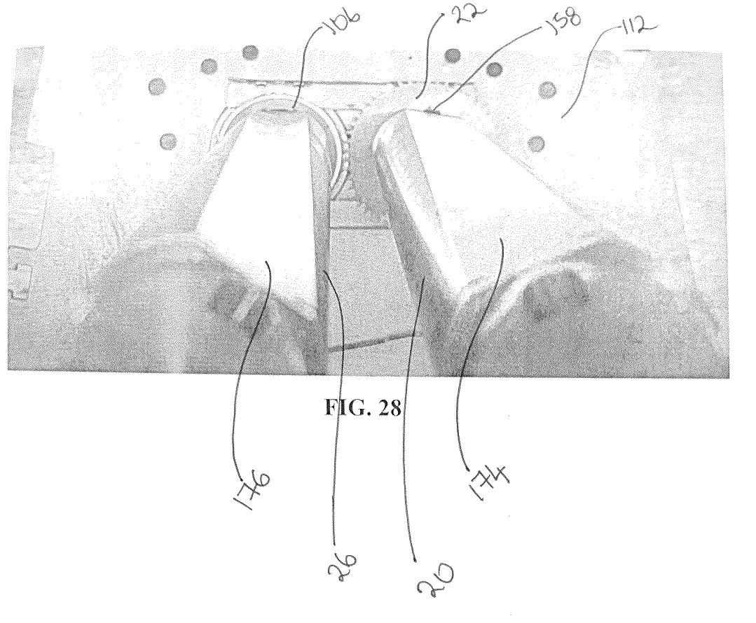

The rotatable shafts 20, 26 may be made of steel material. The rotatable shafts 20, 26 may be made of a metal or a metal alloy material. The rotatable shafts 20, 26 may have a triangular shaped configuration (with rounded corners) at its outer periphery/circumference. The shaped configurations of the rotatable shafts 20, 26 may vary. FIGS. 26 and 28 show the first and second rotatable shafts 20, 26 being connected/coupled to the bearing plate assembly 112, wherein the spacer 106 stacked on the (left) rotatable shaft 26 and the cutter blade 22 stacked on the (right) rotatable shaft 20 are shown in FIG. 26 and wherein the index mark 158 of the (right) cutter blade 22 is being aligned with the index groove 174 of the (right) rotatable shaft 26 in FIG. 28. Referring to FIGS. 26 and 28, each of the rotatable shafts 20, 26 may have an index groove 174, 176 that is configured to align with the index feature 158, 160 of the cutter blades 22, 28.

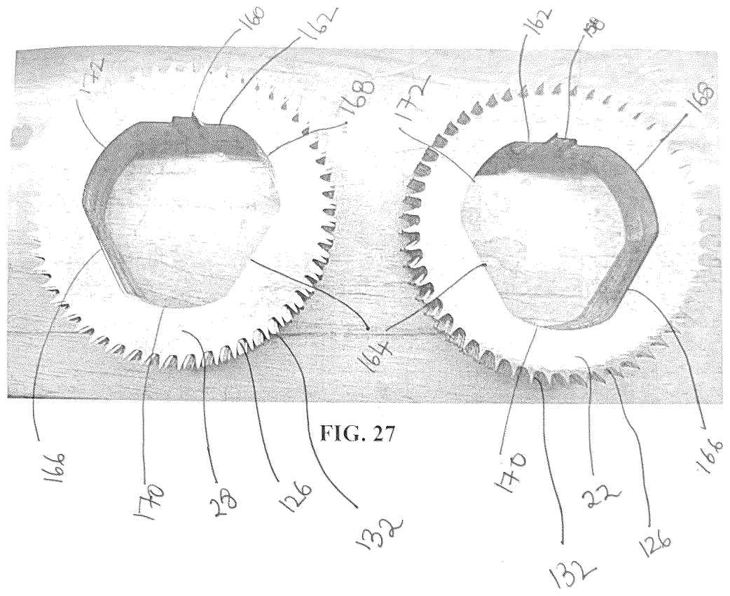

The cutter blades 22, 28 may be made of steel material. The cutter blades 22, 28 may be made of a metal or a metal alloy material. Referring to FIG. 27, each cutter blade 22, 28 may include the index feature/mark 158, 160. The index feature 158, 160 may be in shape of a half arrow. The half arrows may point inward, as shown in FIG. 27, as the cutter blades 22, 28 are being stacked on to their respective rotatable shafts 20, 26. Referring to FIGS. 26 and 28, the index feature 158 on the cutter blade 22 may be configured to align with the index groove 174 of the rotatable shaft 20 when the cutter blade 22, 28 is stacked on to the rotatable shaft 20. The index feature 158, 160 of the cutter blades 22, 28 may be positioned to be on the top of the respective rotatable shafts 20, 26. The indexing features may also be interchangeably referred to as “keying”.

Each cutter blade 22, 28 may include a triangular shaped configuration (with rounded corners) at its inner periphery/circumference to conform with the shape and configuration of the outer periphery/circumference of the corresponding rotatable shafts 20, 26 on to which the cutter blades 22, 28 are mounted. For example, each cutter blade 22, 28 may include three generally flat sides 162, 164 and 166 and three generally rounded corners 168, 170, 172 connecting the sides 162, 164 and 166. In the illustrated embodiment, the indexing feature 158, 160 of the cutter blades 22, 28 may be disposed on the sides 162. The shaped configurations of the inner peripheries of the cutter blades 22, 28 may vary.

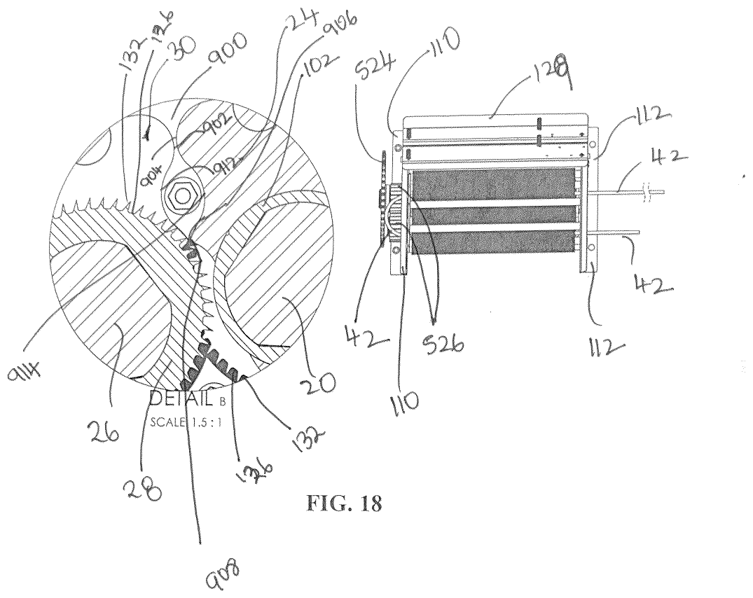

Referring to FIGS. 18, 24 and 27, the cutter blades 22, 28 are cross-cut blades with circumferentially extending edges 126 for longitudinally cutting the paper and radially projecting cutting edges 132 for cross-cutting the paper. The cross-cut blades may be used because the shredded particles are smaller and easier to get into paper retention openings 128, 130 on the strippers 24, 30 (as will be described in detail in the discussions below). The outer peripheries of the cutter blades 22, 28 include the cross-cut blade shapes and configurations. The cutter blades 22, 28 may be slightly thinner than the spacers (or cutter spacers) 102, 106.

The shredder mechanism 14 may also include a first plurality of spacers 102 and a second plurality of spacers 106. The spacers 102 and 106 may be made of steel material. The spacers 102, 106 may be made of a metal or a metal alloy material. Each spacer 102, 106 may include a triangular shaped configuration (with rounded corners) at its inner periphery/circumference to conform with the shape and configuration of the outer periphery/circumference of the corresponding rotatable shafts 20, 26 on to which the spacers 102, 106 are mounted. Each spacer 102, 106 may include three generally flat sides and three rounded corners connecting the three sides. The shaped configurations of the inner peripheries of the spacers 102, 106 may vary. Each spacer 102, 106 may include a generally circular shaped configuration at its outer periphery/circumference to conform with the shape and configuration of the inner periphery/circumference of the corresponding stripper 24, 30 so that the spacer 102, 106 may be nested together with stripper 24, 30. The spacers 102, 106 may have slightly larger thickness than the cutter blades 22, 28.

The strippers 24, 30 may be made of steel material. The strippers 24, 30 may be made of a metal or a metal alloy material. Each stripper 24, 30 may include a generally circular shaped configuration at its inner periphery/circumference to conform with the shape and configuration of the outer periphery/circumference of the corresponding spacers 102, 106 on to which the strippers 24, 30 are mounted.

Some of the paper may get stuck on the rotatable shafts 20, 26 as the paper gets shredded. The stripper may be configured to keep the paper from going around the rotatable shafts 20, 26 and may be configured to knock the paper off the rotatable shafts 20, 26. The stripper may interchangeably referred to as a comb as it may be configured to comb the paper off the rotatable shafts 20, 26.

The cutter blades 22, 28, the strippers 24, 30, and the spacers 102, 106 may be laser cut from a steel, a metal or a metal alloy material. The cutter blades 22, 28, the strippers 24, 30, and the spacers 102, 106 may be subject to a deburring procedure in which small imperfections (generally known as burrs) may be removed from the cutter blades 22, 28, the strippers 24, 30, and the spacers 102, 106. For example, the cutter blades 22, 28, the strippers 24, 30, and the spacers 102, 106 that are made by the laser cut procedure may have small burrs (or “dross”) on the respective bottom surfaces that may be removed by the deburring procedure.

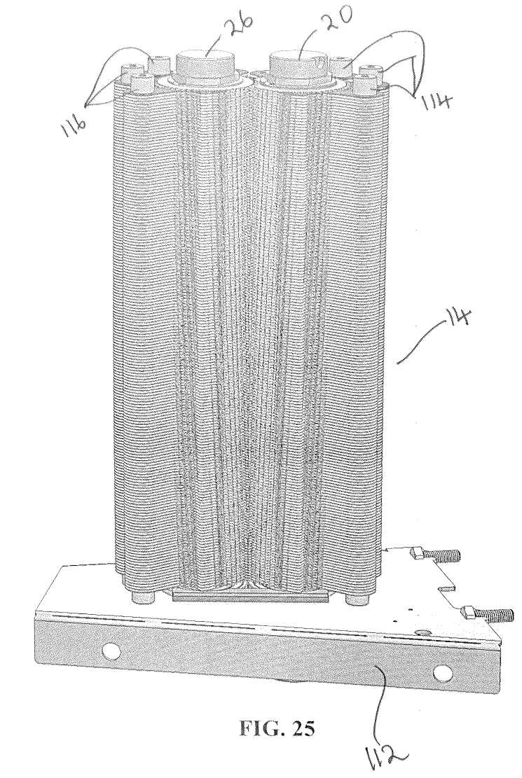

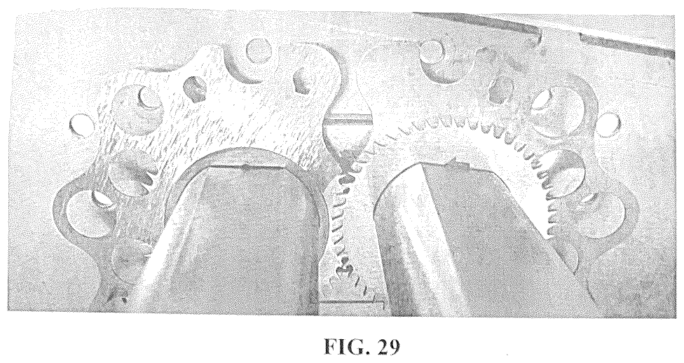

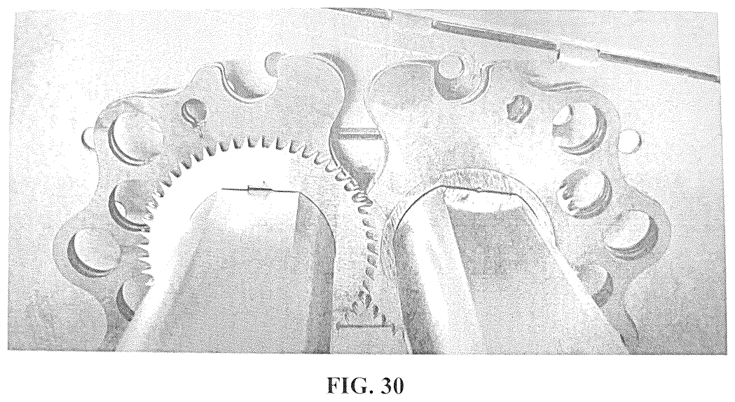

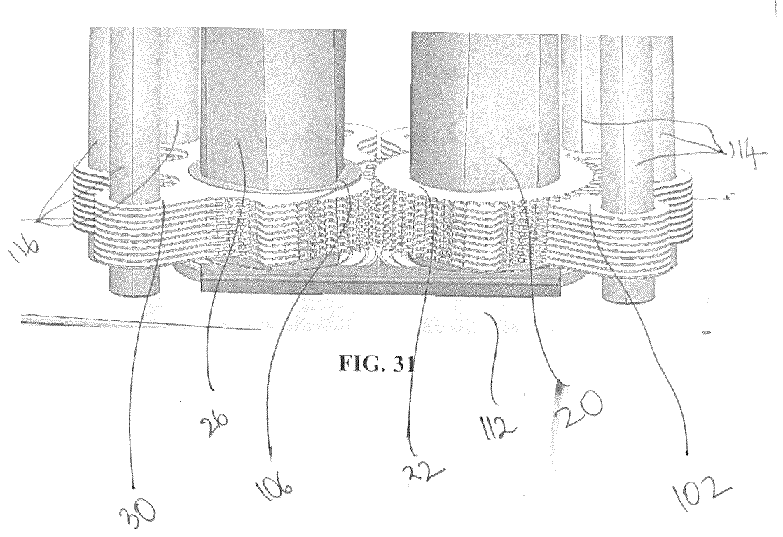

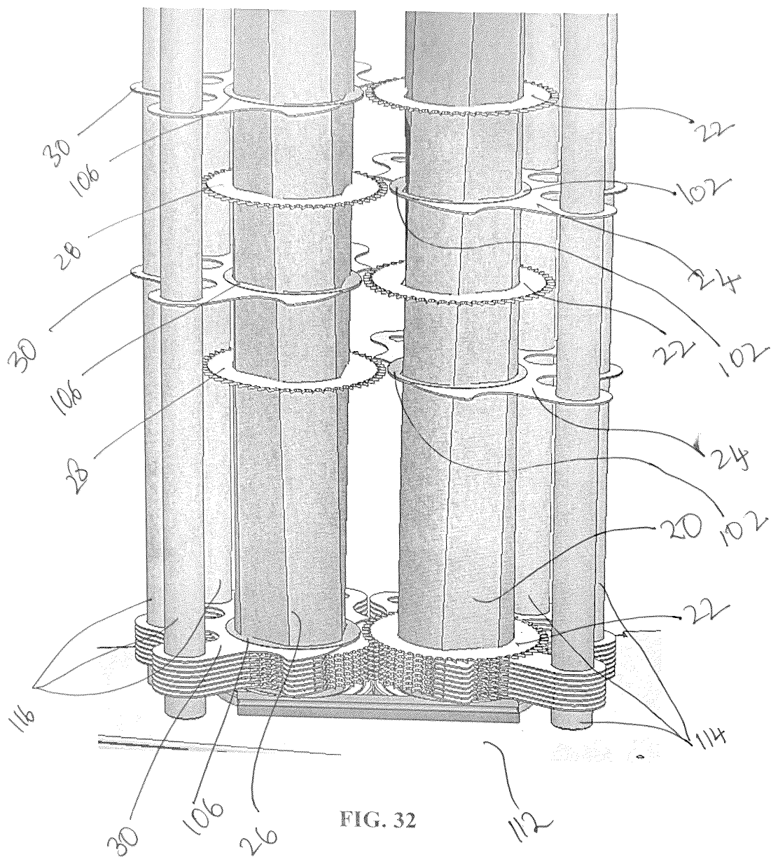

Referring to FIGS. 25-35, the cutter blades 22, 28 and strippers 24, 30 are stacked in a sequential order on both the rotatable shafts 20, 26 until all required components of the shredder mechanism 14 are assembled.

The cutter blades 22, 28, the strippers 24, 30, and the spacers 102, 106 are stacked interlaced onto the rotatable shafts 20, 26 and one end of each shaft 20, 26 is assembled into the bearing plate 110, 112 as shown in FIGS. 25 and 31-32. The cutter blades 22, 28, the strippers 24, 30, and the spacers 102, 106 are stacked interleaved on both left and right shafts 20, 26 simultaneously. The stacking occurs on both (back and forth) so as to create the interlacing needed. The stacking order of the cutter blades 22, 28, the strippers 24, 30, and the spacers 102, 106 onto the cutting/rotatable shafts 20, 26 and the shafts 114, 116 are shown in FIGS. 25 and 31-32.

The first plurality of strippers 24 may include 176 strippers. The second plurality of strippers 30 may include 176 strippers. The number of the first plurality of strippers and the second plurality of strippers may vary. The first plurality of cutter blades 22 may include 177 cutter blades. The second plurality of cutter blades 28 may include 177 cutter blades. The number of the first plurality of cutter blades and the second plurality of cutter blades may vary. The first plurality of spacers 102 may include 177 spacers and the second plurality of spacers 106 may include 177 spacers. The number of the first plurality of spacers and the second plurality of spacers may vary.

For example, each of the rotatable shafts 20, 26 may have 354 layers mounted thereon. The 354 layers may include 177 cutter blades layers, 176 layers each having a combination of the spacer and the stripper (i.e., with the spacer nested together with the stripper), and a spacer (i.e., remaining one of 177 spacers) layer. That is, the shredder mechanism 14 may include 708 layers in total.

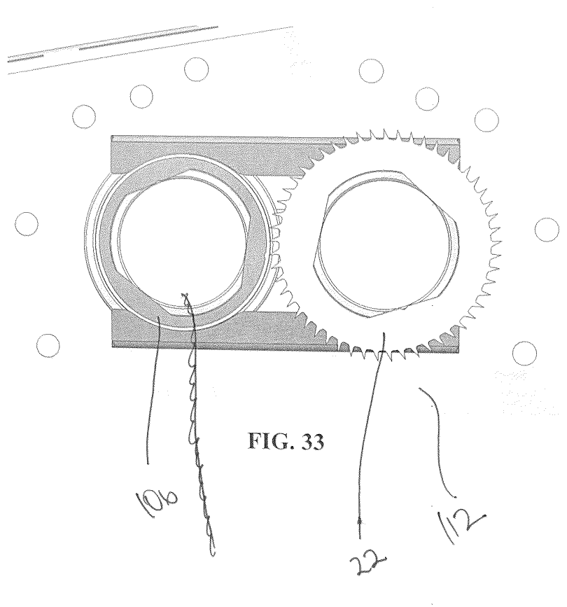

The first layer (i.e., layer 1) and the last layer (i.e., layer 354) on each of the rotatable shafts 20, 26 omit the strippers 24, 30. The first layer may include a cutter blade and the last layer may include a spacer. The first layer may include a spacer and the last layer may include a cutter blade. FIG. 33 shows the strippers 24, 30 are omitted in the first layer on each of the rotatable shafts 20, 26. For example, as shown in FIG. 33, the first layer of the rotatable shaft 20 includes cutter blade 22, while the first layer of the rotatable shaft 26 includes spacer 26 (i.e., without the stripper 30 mounted thereon). The layers 2 to 352 of the 354 layers on each of the rotatable shafts 20, 26 may include alternating layers of the cutter bladers and layers in which the spacer nested together with the stripper.

The stacking sequence may start with layer 1 in which a spacer 102 mounted on the rotatable shaft 20, the stacking sequence may end with layer 354 with the cutter blade 22 mounted on the rotatable shaft 20, and with layers 2 to 352 (between the first layer/layer 1 and the last layer/layer 354) having alternating layers of the cutter bladers 22 and layers in which the spacer 102 nested together with the stripper 24. The stacking sequence may start with layer 1 in which a cutter blade 28 mounted on the rotatable shaft 26, the stacking sequence may end with layer 354 with a spacer 106 mounted on the rotatable shaft 26, and with layers 2 to 352 each having a combination of the spacer 106 and the stripper 30 (i.e., with the spacer 106 nested together with the stripper 30) between the layer 1 and layer 354. In another embodiment, the stacking sequence on the rotatable shaft 26 may reverse of what is discussed above with respect to the rotatable shaft 20. Each of the parts (the cutter blades, the spacers, and/or the spacers and the strippers) may be fully seated during the stacking sequence.

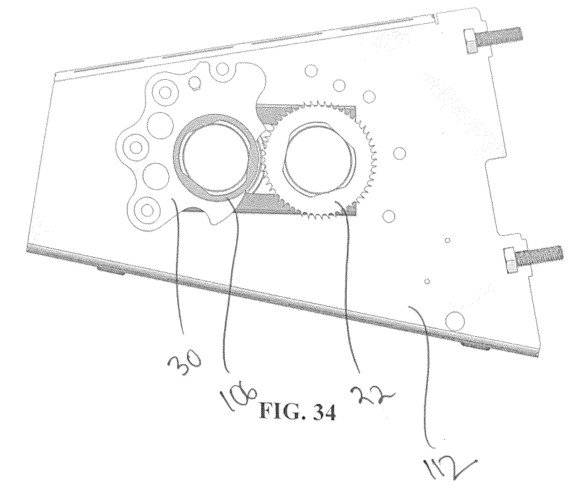

Referring to FIG. 34, the tips of the cutter blade 22 stacked on to the rotatable shaft 20 may be configured to point to the top of the opposite stripper 30 (with the spacer 106 nested therein) stacked on to the rotatable shaft 26.

Prior to the stacking sequence, the cutter blades 22, 28, the spacers 102, 106, and the strippers 24, 30 may be pre-counted by weight and queued on left and right side of assembly workstation.

The shredder mechanism 14 may also include a left bearing plate assembly 110, a right bearing plate assembly 112, and a rear shroud 129. The left bearing plate assembly 110, the right bearing plate assembly 112, and the rear shroud 129 are connected to each other to form a space therebetween to receive the rotatable shafts 20, 26, with the cutter blades 22, 28, the strippers 24, 30 and the spacers 102, 106 mounted on the shafts 20, 26.

Referring to FIGS. 14 and 35, the shredder mechanism 14 may also include a first plurality of stripper shafts 114₁, 114₂, 114₃, and 114₄ and a second plurality of stripper shafts 116₁, 116₂, 116₃, and 116₄. Each of the stripper shafts 114, 116 may have a size of 14 millimeters (outer diameter).

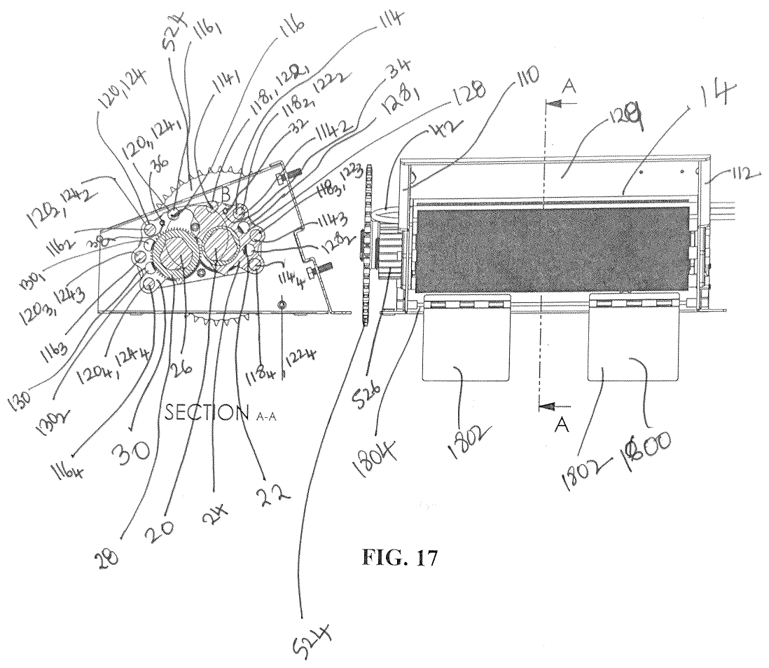

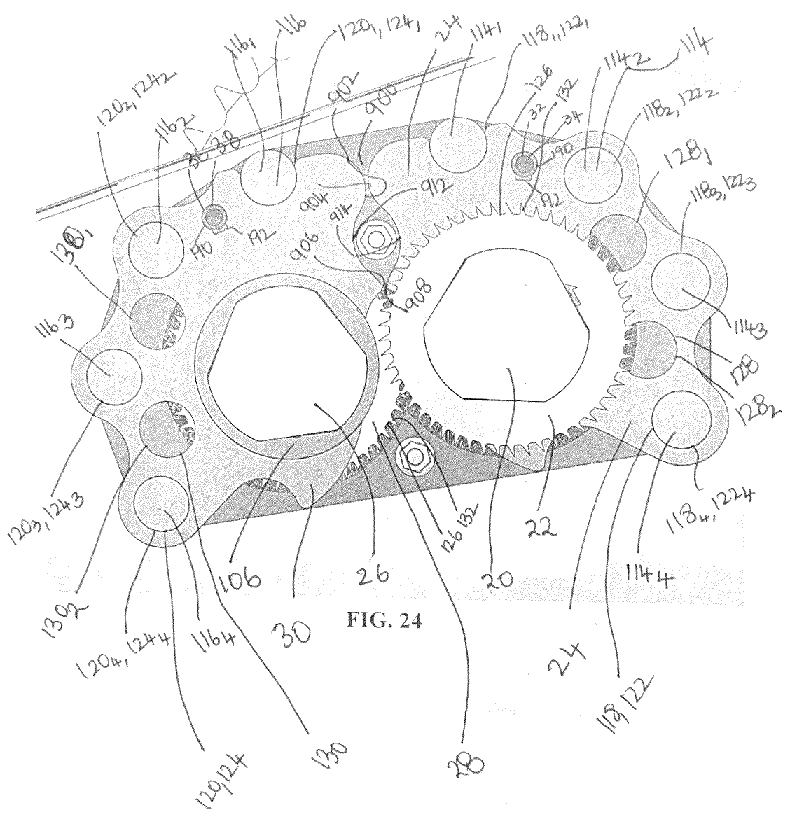

Referring to FIGS. 17 and 24, each first stripper 24 may include a first plurality of stripper shaft openings 118₁, 118₂, 118₃, and 118₄ formed therethrough. Each of the first plurality of stripper shaft openings 118₁, 118₂, 118₃, and 118₄ may be aligned with the respective/corresponding ones to form a first plurality of stripper shaft passages 122₁, 122₂, 122₃, and 122₄. The first plurality of stripper shafts 114₁, 114₂, 114₃, and 114₄ may be configured to be received in the first stripper shaft passages 122₁, 122₂, 122₃, and 122₄, respectively so as to provide a stationary configuration to the strippers 24. In one embodiment, the first stripper shaft openings 118₁ and the first stripper shaft passage 122₁ may be in the form of notches. The notches may be in the form of U-shaped openings. The first stripper shaft openings 118₁ and the first stripper shaft passage 122₁ that are in the form of notches may be disposed on the top of the stripper 24 and may be configured to receive the first stripper shaft 114₁.

Referring to FIGS. 17 and 24, each second stripper 30 may include a second plurality of stripper shaft openings 120₁, 120₂, 120₃, and 120₄ formed therethrough. Each of the second plurality of stripper shaft openings 120₁, 120₂, 120₃, and 120₄ may be aligned with the respective/corresponding ones to form a second plurality of stripper shaft passages 124₁, 124₂, 124₃, and 124₄. The second plurality of stripper shafts 116₁, 116₂, 116₃, and 116₄ may be configured to be received in the second stripper shaft passages 124₁, 124₂, 124₃, and 124₄, respectively so as to provide a stationary configuration to the strippers 30. In one embodiment, the second stripper shaft openings 120₁ and the second stripper shaft passage 124₁ may be in the form of notches. The notches may be in the form of U-shaped openings. The second stripper shaft openings 120₁ and the second stripper shaft passage 124₁ that are in the form of notches may be disposed on the top of the stripper 30 and may be configured to receive the second stripper shaft 116₁.

Each first stripper 24 may include a first lubricant delivery tubing opening 32 formed therethrough. The first lubricant tubing openings 32 of the first strippers 24 are radially offset from the first strippers 24 and aligned with one another to form a first lubricant tubing passage 34 through the first strippers 24. Each second stripper 30 may include a second lubricant delivery tubing opening 36 formed therethrough. The second lubricant tubing openings 36 of the second strippers 30 are radially offset from the second strippers 30 and aligned with one another to form a second lubricant tubing passage 38 through the second strippers 30. The first lubricant delivery tubing passage 34 of the first stripper 24 and the second lubricant delivery tubing passage 38 of the second stripper 30 may be configured to receive portions of the lubricant delivery tubing 42 therethrough. The first and second lubricant tubing openings 32, 36 (and the first and second lubricant tubing passages 34, 38) may be laser cut on their respective strippers 24, 30.

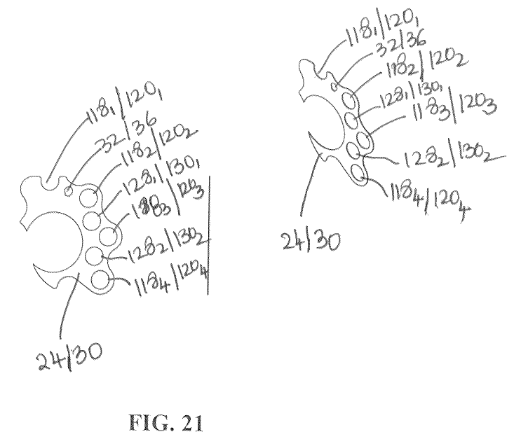

FIG. 21 shows a front and a perspective views of the stripper 24, 30 of the shredder 10. The number of stripper shafts 114, 116, the stripper shaft openings 118, 120, the stripper shaft passages 122, 124, and the lubricant delivery tubing opening/passages 32, 36 and 34, 38 may vary.

Each stripper 24, 30 may include two extra holes 128, 130 that form a special paper particle reservoir and provide an additional feature to help transfer lubricant to the adjacent blade or blades. When shredding paper particles and dust may get captured in these openings 128, 130, the shredded particles absorb the shredder oil and act like a sponge (in a sense). This configuration may also help the cutting block 14 to retain more shredder oil while reduce dripping when the shredder 10 is not in use. Also, the agitation from shredder vibrations over time may cause some of the paper in the openings 128, 130 to occasionally fall out, thus allowing new particles to be collected. This allows for turnover of the particles in the openings retaining the lubricant. These two extra holes 128, 130 of the strippers 24, 30 may interchangeably referred to as paper retention openings 128, 130.

Each stripper 24, 30 may include paper retention opening 128, 130 formed therein. Each paper retention opening 128, 130 may be configured to face axially for capturing paper particles therein from the paper/article shredded between the first and second pluralities of cutter blades 22, 28 to enable the captured paper particles to collect the lubricant therein. For example, each first stripper 24 may have two paper retention openings 128₁, 128₂ and each second stripper 30 may have two paper retention openings 130₁, 130₂. The number of two paper retention openings per stripper may vary.

The paper retention openings 128, 130 may be designed to get paper stuck in them. The paper that is being shredded will get in these openings. The paper being shredded is going to collect the lubricant/oil by absorbing the lubricant/oil. Some papers may technically adsorb as opposed to absorb. As the stripper, as the cutter blades go by, a little bit of extra lubricant/oil in the paper stuck in the paper retention openings 128, 130 may be distributed onto the cutter blades every single time.

Each paper retention opening 128, 130 is aligned at least partially with the first or second pluralities of cutter blades 22, 28 such that at least one adjacent cutter blade 22, 28 at least partially overlaps the paper retention opening 128, 130 (in the radial direction of its shaft) for contact with the paper particles with collected lubricant when captured therein. The partially overlapped configurations of the paper retention openings 128₁, 128₂ with the cutter blade 22 and of the paper retention openings 130₁, 130₂ with the cutter blade 28 are shown in FIGS. 17 and 24.

Each paper retention opening 128, 130 is formed through a thickness of its stripper 24, 30. That is, the paper retention openings 128₁, 128₂ are formed through the thickness of the stripper 24, and the paper retention openings 130₁, 130₂ are formed through the thickness of the stripper 30.

The at least one adjacent cutter blade 22, 28 at least partially overlapping the paper retention opening 128, 130 is a pair of adjacent cutter blades 22, 28 at least partially overlapping the paper retention opening 128, 130 on opposing axial sides thereof. That is, the pair of adjacent cutter blades 22 may be configured to at least partially overlap the paper retention opening 128 on opposing axial sides thereof, and the pair of adjacent cutter blades 28 may be configured to at least partially overlap the paper retention opening 130 on opposing axial sides thereof. Each paper retention opening 128₁, 128₂ has the pair of adjacent cutter blades 22 partially overlapping the paper retention opening 128₁, 128₂ on opposing axial sides thereof. Each paper retention opening 130₁, 130₂ has the pair of adjacent cutter blades 28 partially overlapping the paper retention opening 130₁, 130₂ on opposing axial sides thereof.

The reason for overlapping is so that the lubricant can be wiped on to the cutter blade 22, 28 as the cutter blade 22, 28 passes over the paper retention opening 128, 130 and the paper with the lubricant inside it. The reason for partially overlapping is that the partially overlapped configuration makes it easier to get the paper and the lubricant into the paper retention opening 128, 130 so that the paper with the lubricant can stored therein. Also, over time the shredder vibrations may cause some of the paper to fall out naturally, and then more paper can get collected therein. This helps naturally replace and replenish the paper inside the paper retention opening 128, 130.

In one embodiment, the paper retention openings 128, 130 may be used with the lubricant system 18 described in detail in the present patent application. In other aspects of the present parent application, the paper retention openings 128, 130 can be used with any type of lubricant system, including prior art ones.

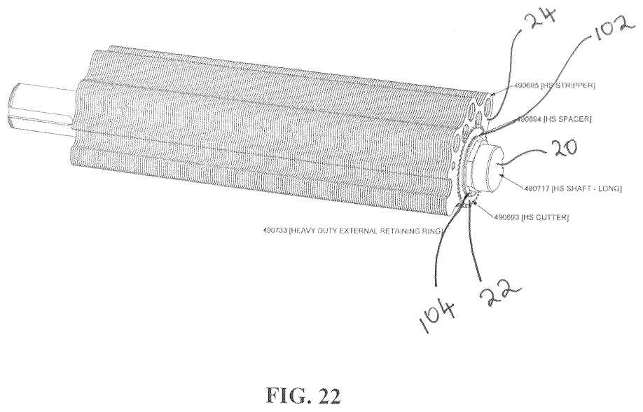

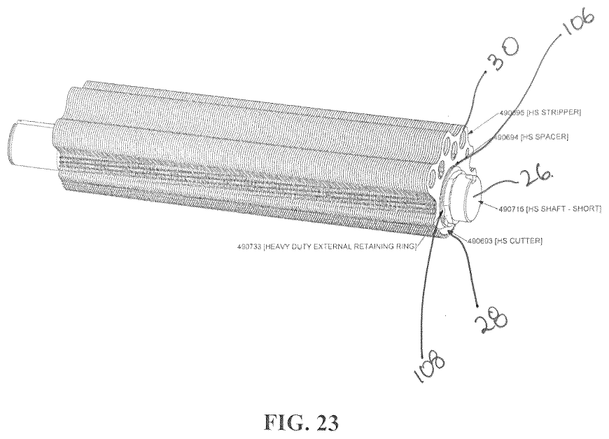

Referring to FIGS. 22 and 23, the shredder mechanism 14 may also include a first pair of retaining rings 104 and a second pair of retaining rings 108. The first and second pair of retaining rings 104, 108 may include heavy duty external retaining rings. Each of the first pair of retaining rings 104 may be disposed at ends of the first rotatable shaft 20, and each of the second pair of retaining rings 108 may be disposed at ends of the second rotatable shaft 26.

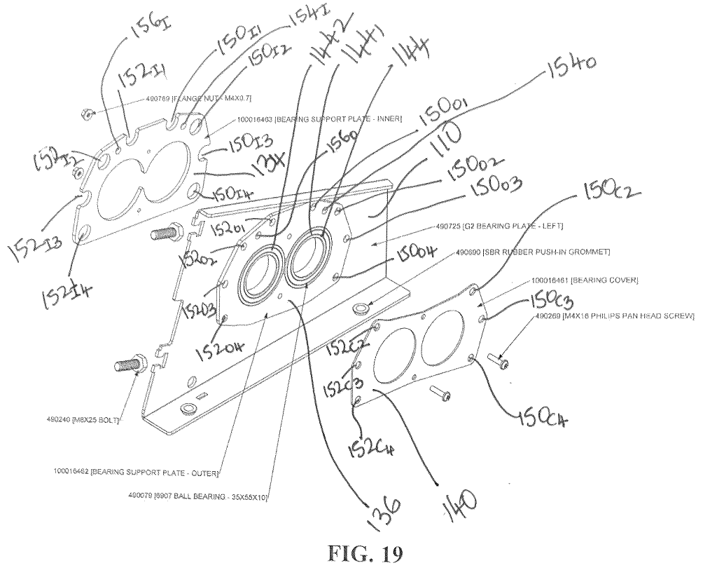

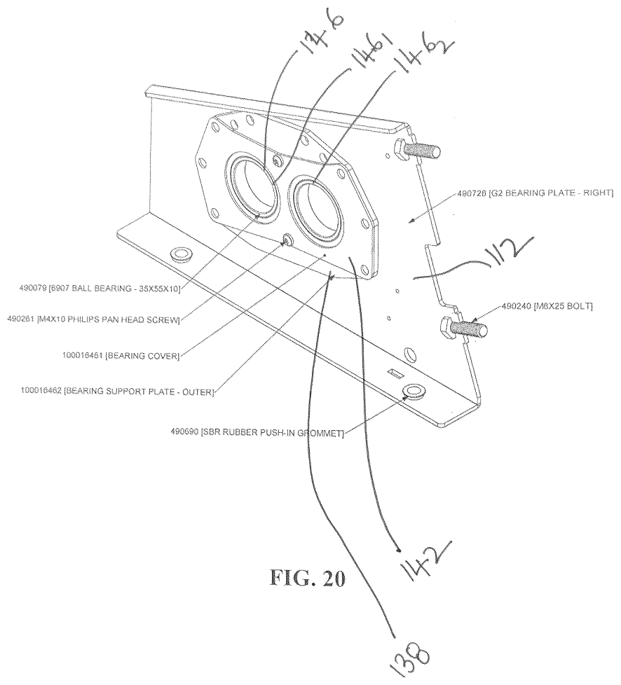

FIG. 19 shows an exploded view of the left bearing plate assembly 110 of the cutting block assembly 14 of the shredder 10, while FIG. 20 shows an assembled view of the right bearing plate assembly 112 of the cutting block assembly 14 of the shredder 10. Each bearing plate assembly 110, 112 may include an inner bearing support member 134 (inner bearing support member for the right bearing plate assembly 112 is not shown), an outer bearing support member 136, 138, a bearing cover member 140, 142, and ball bearings 144, 146. Two ball bearings 144₁, 144₂, 146₁, 146₂ are illustrated for each bearing plate assembly 110, 112. The ball bearings 144₁, 144₂, 146₁, 146₂ may have a size of 35 by 55 by 10. The ball bearings 144₁ and 146₁ may be configured to receive the first rotatable shaft 20, while the ball bearings 144₂ and 146₂ may be configured to receive the second rotatable shaft 26.

The left outer bearing support member 136 may include openings 150_{O1}, 150_{O2}, 150_{O3}, 150_{O4}, 152_{O1}, 152_{O2}, 152_{O3}, and 152_{O4} that are configured to align with openings/notches 150_{I1}, 150_{I2}, 150_{I3}, 150_{I4}, 152_{I1}, 152_{I2}, 152_{I3}, and 152_{I4} of the left inner bearing support member 134 and with openings 150_{C2}, 150_{C3}, 150_{C4}, 152_{C2}, 152_{C3}, and 152_{C4} of the left bearing cover member 140. The left bearing cover member 140 may not include openings that corresponds to the openings 150_{O1} and 152_{O2} of the left outer bearing support member 136 and the opening/notch 150_{I1} and 152_{I1} of the left inner bearing support member 134. The aligned openings 150 of the left outer bearing support member 136, the left inner bearing support member 134, and the left bearing cover member 140 are configured to receive the first plurality of stripper shafts 114₁, 114₂, 114₃, and 114₄ therein. The aligned openings 152 of the left outer bearing support member 136, the left inner bearing support member 134, and the left bearing cover member 140 are configured to receive the first plurality of stripper shafts 116₁, 116₂, 116₃, and 116₄ therein.

The left outer bearing support member 136 may include openings 154_{O} and 156_{O} that are configured to align with openings 154_{I} and 156_{I} of the left inner bearing support member 134. These aligned openings 154 and 156 of the left outer bearing support member 136 and the left inner bearing support member 134 may be configured to receive portions of the lubricant delivery tubing 42. The left bearing cover member 140 may not include openings that corresponds to the openings 154_{O} and 156_{O} of the left outer bearing support member 136 and the openings 154_{I} and 156_{I} of the left inner bearing support member 134.

The other two openings (shown but not labeled in FIG. 19) of the left outer bearing support member 136, the left bearing cover member 140, and the left inner bearing support member 134 may be configured to connect the left outer bearing support member 136, the left bearing cover member 140 and the left inner bearing support member 134 to each other.

Although not specifically labeled in or discussed with respect to FIG. 20, the discussions of the aligned openings of the left outer bearing support member 136 to receive the stripper shafts and the aligned openings of the left outer bearing support member 136 to receive the lubricant delivery tubing of the left outer bearing support member 136 may be equally applicable to the right bearing plate assembly 112.

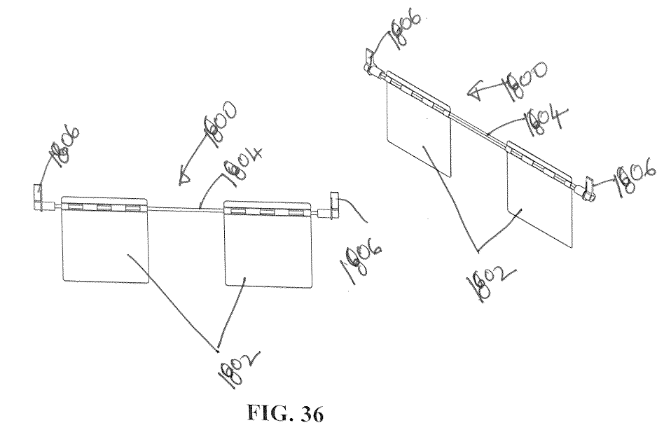

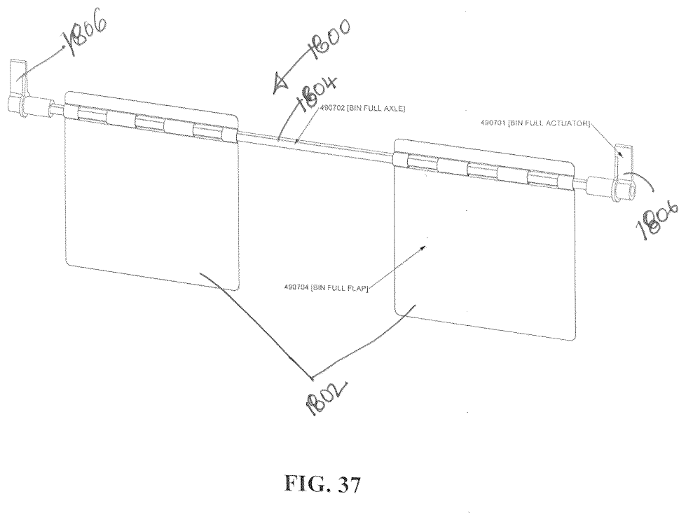

Referring to FIGS. 14, 16-17, and 36-37, the shredder 10 may include a bin full assembly 1800. The bin full assembly 1800 may include bin full flaps 1802, a bin full axle 1804, bin full actuators 1806, and a bin full switch 1808. Two bin full flaps 1802 and two bin full actuators 1806 are shown in the illustrated embodiments. The number of the bin full flaps and the bin full actuators may vary and may depend on the number of bins in the bin assembly 600. As two waste bins 602, 604 are used in some embodiments of the present patent application, this may require dual bin full sensor assembly 1800. The flaps 1802 may be made of nylon material. The shaft 1804 may include a square cross-sectional configuration. The two nylon flaps 1802 may be woven onto the square shaft 1804. Both bins 602, 604 may usually fill at about the same rate, however, the bin full assembly 1800 may be configured to detect highest level in any waste basket 602 or 604.

The bin full assembly 1800 may be configured to detect if one (or both) of the bins 602, 604 of the bin assembly 600, received in the cabinet assembly 300, is full during the operation of the shredder 10. The bin full assembly 1800 may be disposed on the housing 12/the cabinet assembly 300 and/or portions of the bin assembly 600. The signals from the bin full assembly 1800 may be configured to be sent to the controller C, which in turn may be configured to control the motor 16 based on the received signal. For example, when a signal from the sensor (sent to the controller C) indicates that one (or both) of the bins 602, 604 of the bin assembly 600 is full during the operation of the shredder 10, the controller C may be configured to stop the operation of the motor 16. The controller C may also be configured to provide an indication to a user that one (or both) of the bins 602, 604 of the bin assembly 600 is full or when the contents of the bin assembly 600 should be emptied. Failure by a user to recognize that the bin assembly 600 is full may result in overfilling, jamming, a paper mess, or other hazardous condition.

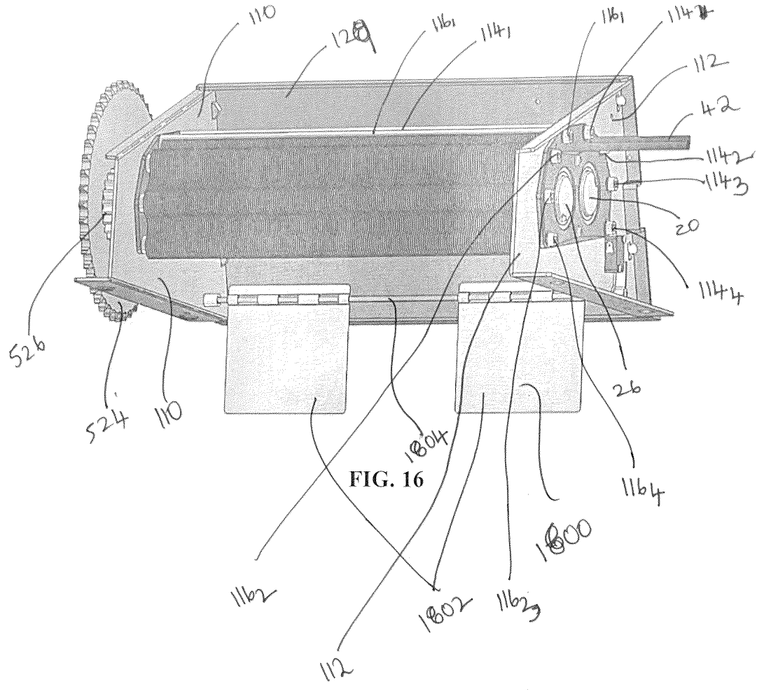

The bin full flaps 1802 may be configured to lift or rotate upwards as the bin (either or both) fills with shredded material. As the bin full flaps 1802 rotate upwards, the tab actuator 1806 may be configured to rotate and engage with a micro lever switch (shown in FIG. 16) that in turn sends a signal to the controller C. The controller C may then be configured to power the bin full LED icon to light up on the control panel and also may then be configured to shut power off to the shredder motor until the bins (has been emptied, reinserted, bin full flaps 1802 resume their vertical orientation and the cabinet door closed allowing the motor to be powered again to either start a new shredding event or resume the prior interrupted event.

As shown in FIG. 17, the flaps 1802 are pivotally attached to the bin side (underside) of the shredder mechanism 14 between the output of the shredder mechanism 14 and the access opening of the bin assembly 600 (not shown in FIG. 17). Pivotal attachment of the flaps 1802 may include a simple pivotal attachment about a pivot axis (e.g., of the axle/shaft 1804). Pivotal attachment of the flaps 1802 may include hinges and/or other attachment members. The pivotal attachment may include an attachment for compound movement that may include multiple axes or other types of movement (such as linear movement). The flaps 1802 are configured to rotate freely about the axle/shaft 1804 when not impinged by any other forces. As such, when the shredder mechanism 14 is placed upon the bin assembly 600 and the bin assembly 600 is empty, the flaps 1802 are in a first position in which it hangs freely under gravity from the shredder mechanism 14 in a downward direction. As the bin assembly 600 becomes full of paper and/or other materials, the contents will begin to push against the flaps 1802 from the shredder side of the flaps 1802 and towards the access opening of the bin assembly 600. The accumulation of shredded materials will eventually be enough to push and rotate the flaps 1802 to a second position, which may be approximately 45 to 60 degrees from the first position.

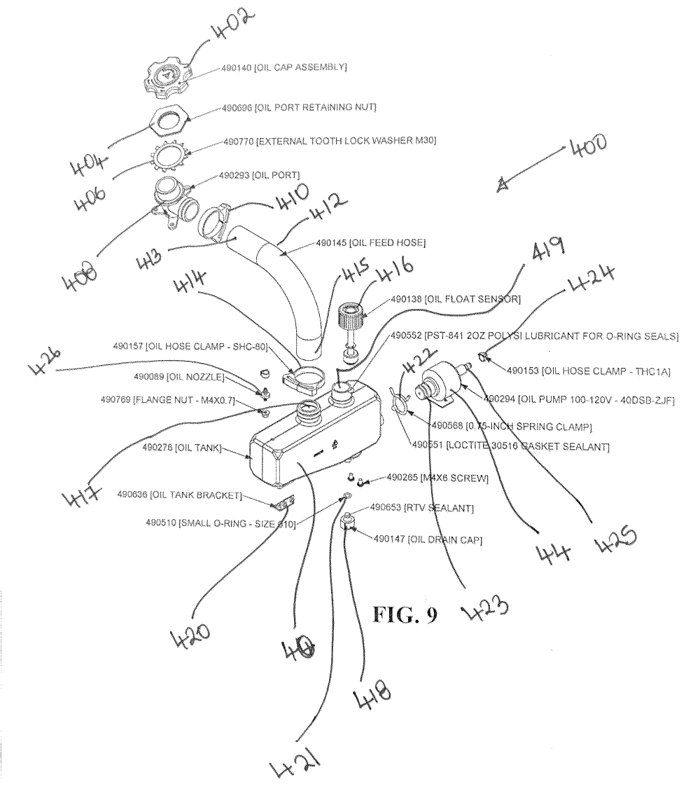

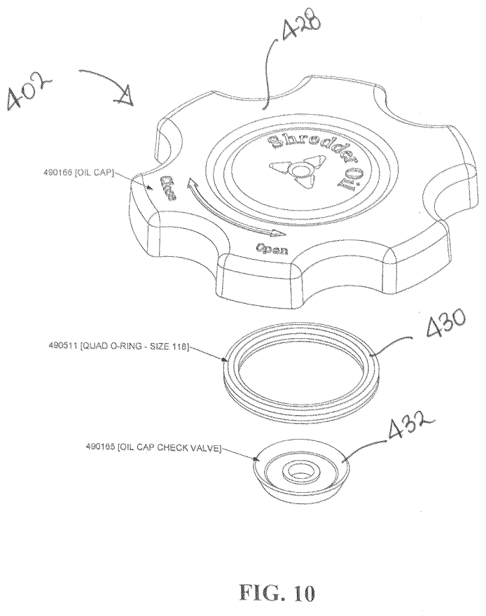

FIG. 9 shows a lubricant reservoir assembly 400 and FIG. 10 shows a lubricant cap assembly 402 of the lubricant reservoir 40. The liquid lubricant may interchangeably be referred to as oil in the below discussions.

The lubricant system 18 may include the lubricant reservoir assembly 400 including the lubricant reservoir 40, the lubricant pump 44 and the lubricant cap assembly 402. The lubricant system 18 may also include the lubricant delivery tubing 42. Each of these components of the lubricant system 18 will be described in detail below.

As will be clear from the discussions below, the lubricant system 18 may be a closed loop (oil/lubricant) system. The lubricant may be pumped by the lubricant pump 44 from the lubricant reservoir 40. The lubricant may be passed through the lubricant delivery tubing 42 (e.g., passing through the cutting block/shredder mechanism 14) to lubricate the cutter blades 22, 28 and the strippers 24, 30 in the shredder mechanism 14, and the lubricant may be routed back to the lubricant reservoir 40.

Referring to FIG. 9, the lubricant reservoir assembly 400 may include the lubricant cap assembly 402, a lubricant port retaining nut 404, a lock washer (e.g., an external tooth lock washer) 406, a lubricant port 408, a lubricant hose clamps 410, 414, a lubricant feed hose 412, a lubricant float sensor 416, a lubricant drain cap 418, a lubricant reservoir bracket 420, the lubricant pump 44, a spring clamp 422, a lubricant nozzle 426, and a lubricant hose clamp 424. The lubricant nozzle 426 may be a check valve that allows air to enter the tank while the pump operates.

Referring to FIG. 10, the lubricant cap assembly 402 may include a lubricant cap 428, an O-ring 430 (e.g., quad O-ring having a size of 118), and a lubricant cap check valve 432. The lubricant cap 428 may be configured to cover the lubricant port 408 and the liquid lubricant filler opening 417 of the lubricant reservoir 40. When the cap 428 is moved to an “open” position, the check valve 432 is moved to its open position. In its open position, the check vale 432 may be configured to allow forward flow of the liquid lubricant into the liquid reservoir 40. When the cap 428 is moved to a “closed” position, the check valve 432 is moved to its closed position. In its closed position, the check valve 432 is configured to block reverse flow of the liquid lubricant from the liquid reservoir 40. The O-ring 430 may be positioned/disposed between the check valve 432 and the cap 428. The O-ring 430 may be configured to provide sealed configuration at the connection between the check valve 432 and the cap 428.

The lubricant reservoir 40 may be configured for containing a supply of liquid lubricant. The liquid lubricant may be interchangeably referred to as lubricant, lubricating fluid, etc. The liquid lubricant may be oil, such as soybean oil, vegetable oil, mineral oil or other oils. Other lubricants may be used, including other types of liquid lubricants. The lubricant reservoir 40 may interchangeably referred to an oil tank or a lubricant tank. The lubricant reservoir 40 may be configured and designed to be re-filled. The lubricant reservoir 40 may have a fill neck that extends through one of the walls of the shredder housing 12 to allow for easy access for refilling the lubricant reservoir 40. The lubricant reservoir 40 may also be configured and designed to be easily removed and replaced if damaged.

The lubricant port 408 may be configured to provide liquid lubricant to the lubricant reservoir 40 via the lubricant feed hose 412. The lubricant hose clamp 410 may be configured to connect one end 413 of the lubricant feed hose 412 to the lubricant port 408, while the lubricant hose clamp 414 may be configured to connect the other end 415 of the lubricant feed hose 412 to the lubricant reservoir 40. The lubricant hose clamps 410, 414 may include hose clamps with model number SHC-80. The lubricant reservoir 40 may have a first opening 417 that is configured to receive portions of the end 415 of the lubricant feed hose 412 therein. The lubricant reservoir bracket 420 may be configured to support and connect the lubricant reservoir 40 to portions of the housing 12 of the shredder 10.

The lubricant float sensor 416 may be configured to sense a level of liquid lubricant in the lubricant reservoir 40. That is, the lubricant reservoir lubricant liquid level data may be acquired by the lubricant float sensor 416. This data may then be converted into corresponding (residual) lubricant quantity (i.e., in the lubricant reservoir 40) data. The lubricant reservoir 40 may have a second opening 419 to receive portions of the lubricant float sensor 416 therein. A silicone O-ring Lubricant (e.g., PolySi PST-841, 2 ounces, for O-ring seals) may be used at the connection between the second opening 419 of the lubricant reservoir 40 and lubricant float sensor 416.

The lubricant drain cap 418 may be a screw plug with a sealing ring (e.g., O-ring 421, for example, having a size 010). The sealing ring may be configured to seal a drain opening (not shown) of the lubricant reservoir 40. The drain opening may be a third opening of the lubricant reservoir 40. The drain opening may be needed to drain waste lubricant when changing the lubricant before refilling. A Room Temperature Vulcanizing (RTV) sealant may be used at the connection between the lubricant drain cap 418 and the drain opening of the lubricant reservoir 40.

The lubricant delivery tubing 42 may be communicated in the closed loop to the lubricant reservoir 40 and routed through both the first and second lubricant tubing passages 34, 38. The closed loop is configured to enable the lubricant to flow from the lubricant reservoir 40, through the lubricant delivery tubing 42 and back to the lubricant reservoir 40. The lubricant delivery tubing 42 may be communicated in the closed loop to the lubricant reservoir 40. The term “closed loop” as used herein refers to a closed loop lubricant flow path or circuit between the lubricant delivery tubing 42 and the lubricant reservoir 40 (and/or the lubricant pump 44 connected to the lubricant reservoir 40). That is, some of the lubricant in the lubricant delivery tubing 42 may be used to lubricant the shredder mechanism 14 and the remaining lubricant may be recirculated back the lubricant reservoir 40 after the lubrication of the shredder mechanism 14. The lubricant delivery tubing 42 may include one or more lubricant delivery conduits that are communicated to the lubricant reservoir 40 for delivering a portion of the liquid lubricant flowing therethrough to lubricate the strippers 24, 30 and the cutter blades 22, 28.

The lubricant delivery tubing 42 may be configured to run through the first and second lubricant tubing openings 32, 36 (and the first and second lubricant tubing passages 34, 38) of the strippers 24, 30. The lubricant delivery tubing 42 may be configured to lubricate/oil every spacer 102, 106 from above such that the lubricant/oil moves into the cutter blades 22, 28 by capillary action.

The lubricant delivery tubing 42 is configured to be permeable to the liquid lubricant through the surface 46 thereof along portions 56 disposed within the first and second lubricant tubing passages 34, 38 for delivering a portion of the liquid lubricant flowing therethrough to lubricate the strippers 24, 30 and the cutter blades 22, 28. The term “permeable” as used herein, e.g., with respect to the lubricant delivery tubing 42, may include a material or a construction/configuration of the lubricant delivery tubing 42 that is configured to permit passage of the liquid lubricant or allow the liquid lubricant to pass/diffuse therethrough. For example, the construction/configuration of the lubricant delivery tubing 42 may include a plurality of perforations 54 through the surface 46 thereof as discussed in detail below.

The lubricant may not have time to dry out in the lubricant delivery tubing 42. The lubricant delivery tubing 42 may have a 5 mm (or 0.197 inches) inner diameter and 6.38 mm outer diameter. The lubricant delivery tubing 42 may also be a manifold. The lubricant delivery tubing 42 may have no extra connections to cause any potential leaks. The lubricant delivery tubing 42 may be made of polyurethane material.

The lubricant delivery tubing 42 may be provided with the plurality of perforations 54 through the surface 46 thereof along the portions 56 disposed within the first and second lubricant tubing passages 34, 38 to be permeable to the liquid lubricant. The plurality of perforations 54 may include approximately 334 perforations. The perforations 54 may be laser perforated. The lubricant may be dispersed from the 334 individual laser perforated lubricant perforations through the polyurethane lubricant delivery tubing 42 to deliver lubricant to each cutter/spacer/stripper group.

Referring to FIG. 24, the first and second lubricant tubing openings 32, 36 (and the first and second lubricant tubing passages 34, 38) may have generally circular shaped cross-sectional configuration 190 with a rectangular shaped cross-sectional configuration 192 at its bottom. The rectangular shaped cross-sectional configuration 192 at the bottom may enable to unblock the perforations 54 on the lubricant delivery tubing 42 that may be aligned with the stripper.

Referring to FIG. 14, the lubricant delivery tubing 42 may be a single lubricant delivery tube 42_{S} routed in one direction D₁ through the first lubricant tubing passage 34 and then back in an opposite direction D₂ through the second lubricant tubing passage 38 with a bight portion 48 extending between the first and second lubricant tubing passages. The single lubricant delivery tube 42_{S} may have its opposing ends 50, 52 communicated to the lubricant reservoir 40 to establish the closed loop.

Referring to FIG. 14, the lubricant delivery tubing 42 may comprise a first lubricant delivery tube 42₁ and a second lubricant delivery tube 42₂. The first lubricant delivery tube 42₁ may be routed through the first lubricant tubing passage 34 and the second lubricant delivery tube 42₂ may be routed through the second lubricant tubing passage 38. Each of the first and second lubricant delivery tubes 42₁, 42₂ may include its opposing ends 50, 51 and 53, 52 communicated to the lubricant reservoir 40 to establish the closed loop.

The lubricant pump 44 may be configured to draw the liquid lubricant from the lubricant reservoir 40. The lubricant pump 44 may be configured for pumping the liquid lubricant from the lubricant reservoir 40 through the lubricant delivery tubing 42.

The spring clamp 422 may be configured to connect one end 423 of the lubricant pump 44 to the lubricant reservoir 40, while the lubricant hose clamp 424 may be configured to connect the other end 425 of the lubricant pump 44 to one end of the lubricant delivery tubing 42. A Loctite 30516 gasket sealant may be used at the connection between the spring clamp 422 and the end 423 of the lubricant reservoir 40. The spring clamp 422 may include 0.75 inch spring clamp. The lubricant hose clamp 424 may include THC1A hose clamp. The lubricant pump 44 may be a micro pump (e.g., model number 40DSB-ZJF). The lubricant pump 44 may be a solenoid pump. The lubricant pump 44 may be use 100-120 Volts (V).

In operation, the controller C may be programmed with instructions for determining when to lubricate the cutting blade 22, 28 and the strippers 24, 30. The controller C may be configured to process the instructions and subsequently apply them by activating the lubricant pump 44 to cause the liquid lubricant from the lubricant reservoir 40 to be delivered to the lubricant delivery tubing 42. The lubricant delivery tubing 42 may be positioned and arranged and/or configured to be permeable to the liquid lubricant through the surface 46 thereof along the portions 56 disposed within the first and second lubricant tubing passages 34, 38 for delivering a portion of the liquid lubricant flowing therethrough to lubricate the strippers 24, 30 and the cutter blades 22, 28.

Within the scope of the present patent application, the controller C may be programmed to operate the lubricant pump 44 in a number of different modes. The controller C may be programmed to operate according to a predetermined timing schedule. The controller C may activate the lubricant pump 44 upon a certain number of rotations of the drive for the cutting elements 22, 28. A sensor (not shown) at the throat of the shredder 10 may be configured to monitor a thickness of items deposited therein. Upon accumulation of a predetermined total thickness of material shredded, the controller C may be configured to activate the lubricant pump 44 to lubricate the cutting elements 22, 28. It is also possible to schedule the lubrication based on a number of uses of the shredder 10 (e.g., the controller C may be configured to track or count the number of shredding operations and activate the lubricant pump 44 after a predetermined number of shredder operations). In each of the embodiments making use of accumulated measures, a memory device may be incorporated for the purpose of tracking use. In each foregoing embodiment, the lubricant system 18 may also include a manual control to allow a user to operate the lubricant system 18 outside of the schedule determined by the controller C. A user-activated button may be used to manually engage the lubricant pump 44.

The controller C may be configured to monitor a load on the motor 16. A large load on the motor 16 may be indicative of resistance to the motion of the cutting blades 22, 28, in turn indicating that a large amount of paper or a relatively tough substrate such as a CD is being shredded. The load monitoring function may be used as a trigger for lubrication of the cutting blades 22, 28 and/or the strippers 24, 30. For example, a current or voltage sensor may sense the resistance across the shredder mechanism's motor 16. An increase in the voltage drop across the motor 16 (or a decrease in current flaming to the motor 16) may indicate an increase in the mechanical resistance faced by the motor 16. As such, when the electrical resistance, voltage drop, or current (all of which are related, so anyone may be monitored directly or Indirectly) reaches a threshold valve, the controller C may activate the lubricant pump 44 to pump the liquid lubricant from the liquid reservoir 40 through the liquid delivery tubing 42.

Only rated capacity with small tolerance may be allowed to enter the cutting block/shredder mechanism 14. Paper capacity restricting features may also be configured to provide some paper tensioning and support. Referring to FIG. 24, the shredder 10 includes a restrictor/paper tensioner 900. The restrictor 900 (may also be referred to as a restrictor segment) may be configured to limit the number or thickness of papers/articles that can be inserted. The restrictor 900 may include a surface 902 of the stripper 30 and a surface 904 of the stripper 24. The surfaces 902, 904 may interchangeably referred to as paper restrictor portions. The restrictor 900 may be referred as paper receiving opening. For example, the first paper restrictor portion 904 of one of the strippers 24 of the first plurality and the second paper restrictor portion 902 of an adjacent one of the strippers 30 of the second plurality may be configured to form the paper receiving opening 900, which may be configured to limit the number or thickness of the at least paper received by the shredder mechanism 14.

Also, referring to FIGS. 18 and 24, each stripper 24, 30 may have stationary anvil 908, 906 to initiate paper piercing as early as possible. Each of the strippers 24, 30 of the first plurality may be configured to be stationary with respect to the first rotatable shaft 20. Each of the strippers 24, 30 of the second plurality may be configured to be stationary with respect to the second rotatable shaft 26. This stationary anvil configuration may be configured to improve cut quality and reduce paper wrinkling (also referred to as flutter). The anvil may interchangeably referred to as anvil portion. That is, each of the strippers 24, 30 of the first plurality may have the first anvil portion 906. Each of the strippers of the second plurality may have the second anvil portion 908.

The first anvil portion 906 of each of the strippers 24 of the first plurality may be configured to support the at least paper laterally while each of the cutter blades 28 of the second plurality penetrates the at least paper. The second anvil portion 908 of each of the strippers 30 of the second plurality may be configured to support the at least paper laterally while each of the cutter blades 22 of the first plurality penetrates the at least paper. The anvil 908 may be configured such that the cutter blades 22 on the opposite side are right up against the anvil 908 of the stripper 30. The anvil 906 may be configured such that the cutter blades 28 on the opposite side are right up against the anvil 906 of the stripper 24. The anvil 908, 906 may also be interchangeably referred to as piercing anvil.

Each of the first anvil portion 906 and the second anvil portion 908 may have a non-elongated shaped configuration. The first anvil portion 906 may have a first projection 906 that may have either angled or convex shaped so that the cutter blades 28 of the second plurality that are adjacent the first anvil portion 906 are configured to pierce the at least paper near the first projection 906. The second anvil portion 908 may have a second projection 908 that may have either angled or convex shaped so that the cutter blades 22 of the first plurality that are adjacent the second anvil portion 908 are configured to pierce the at least paper near the second projection 908.

For example, the point of the anvil 908, 906 may be angled or convex, so that both the cutter blades 22 above and below that stripper 24 can pierce right at that point or both the cutter blades 28 above and below that stripper 30 can pierce right at that point.

The first projection 906 and the first paper restrictor portion 904 may be configured to create tension on the at least paper as the at least paper passes through the first projection 906 and the paper receiving opening 900. The second projection 908 and the second paper restrictor portion 902 may be configured to create tension on the at least paper as the at least paper passes through the second projection 908 and the paper receiving opening 900.

A relief profile 910 may be disposed just after the restrictor 900 and before/prior to the anvil 908, 906, that is, along the direction of travel of the paper/article being shredded. The relief profile 910 may be interchangeably referred to as relief space.

Each of the strippers 24 of the first plurality may include a first relief portion 912. The first relief portion 912 may be positioned between the first paper restrictor portion 904 and the first anvil portion 906. Each of the strippers 30 of the second plurality may include a second relief portion 914. The second relief portion 914 may be positioned between the second paper restrictor portion 902 and the second anvil portion 908.

The first relief portion 912 of one of the strippers 24 of the first plurality and the second relief portion 914 of an adjacent one of the strippers 30 of the second plurality may be configured to form the relief space 910. The relief space 910 may be configured to be wider than the paper receiving opening 900 and the relief space 910 may be configured to reduce jamming of the at least paper due to a paper wrinkle or a paper fold.

The shape of the relief profile 910 may be purposefully relieved so as to allow the non-elongated anvil shape to initiate the more effective piercing action when the cutter blades 22, 28 sequentially rotate. For example, the shape of the relief profile 910 may include an open region formed between the surface/first relief portion 912 of the stripper 30 and the surface/second relief portion 914 of the stripper 24. The shape of the relief profile 910 may include a substantially oval shape or shaped configuration. The relief space may help with fast fold. That is, if the paper wrinkles as it enters the shredder, the relief space may prevent creation of excess friction. The relief space may minimize the contact to two points vs. along the entire upper stripper profile. This is important since the microcut has so many additional stripper components.

By contrast to the Application '092 (the prior art discussed in the background section of the present patent application), the purposefully configured piercing anvil profile shape that allows for paper stack to be displaced by the tips of the cutter blades as the cutter blades sequentially rotate on both the upper and lower sections about the anvil's tip. This effectively initiates the dual piercing and cutting actions (i.e., the actions of the cutter tips and the apex of the anvil working in unison).

The controller C may include one or more processors P. The controller C may include a control circuit. However, the controller C may alternatively include any other type of suitable controller without deviating from the scope of the present patent application. For example, the controller C may include a processor P executing code; an integrated computer system running a program; analog or digital circuitry; etc. The controller C may also be a relay switch that opens to disable the delivery of power to an element (e.g., the motor 16 of the shredder 10) and closes to enable the delivery of power. It is to be appreciated that controller may be a generic structural term that denotes structure(s) that control one or more modules, devices, and/or circuit components. The shredder 10 also may include a memory device connected to, or integral with, the controller C for storing information related to the shredder 10. The stored information, for example, may include predetermined threshold ranges, predetermined criteria, determined cycles, patterns and usage flows of the shredder 10. Referring to FIG. 1, the controller C may include a power supply PCB 178 and an AC PCB 180.

The controller C may store information within the memory device and may subsequently retrieve the stored information from the memory device. The memory device may include any suitable type of memory, such as, for example, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory or any other suitable memory.

The shredder 10 may include a solid state relay SSR that is an electronic switching device that switches on or off when an external voltage (AC) is applied across its control terminals. The solid state relay may be more reliable and less prone to welding closed due to arcing. The solid state relay SSR may serve the same function as an electromechanical relay, but solid-state electronics contain no moving parts and have a longer operational lifetime.

The shredder 10 may include a motor capacitor 182 as shown in FIG. 1. The motor capacitor 182 may be a 75 microfarads motor capacitor. With the motor capacitor 182, the motor 16 may be configured to set the rotation direction. The motor capacitor 182 may provide starting torque for the motor 16 and increase torque during operation.

Referring to FIG. 1, the shredder 10 includes an IEC-320 C20 186 (i.e., a male connector on the shredder 10 being powered) and a power switch 184 or a plurality of switches may be provided to control operation of the shredder 10. The power switch 184 may be provided on the shredder housing 12, for example, or anywhere else on the shredder 10. The power switch 184 may include a manually engageable portion connected to a switch module (not shown). Movement of the manually engageable portion of the power switch 184 moves the switch module between states. The power switch 184 may be a rocker switch, for example. The switch module may connect the motor 16 to a power supply. This connection may be direct or indirect, such as via the controller C. The switch module is communicated to the controller C. Typically, a power supply is connected to the controller C by the standard power cord PC with a plug on its end that plugs into a standard AC outlet. The controller C is likewise communicated to the motor 16 of the shredder mechanism 14.

The switch or switch module may be movable between an on position and an off position by moving the manually engageable portion. In the on position, contacts in the switch module are closed by movement of the manually engageable portion to enable a delivery of electrical power to the motor 16. The controller C may send an electrical signal to the drive of the motor 16 so that the motor 16 rotates the cutting blades 22, 28 of the shredder mechanism 14 in a shredding direction, thus enabling paper sheets to be fed therein. In the off position, contacts in the switch module are opened to disable the delivery of electric power to the motor 16. The controller C to stop operation of the motor 16. Alternatively, the switch may be coupled to the controller C, which in turn controls a relay switch, triac, etc. for controlling the flow of electricity to the motor 16. Further, the power switch 184 may also have an idle or ready position, which communicates with a control panel. The switch module contains appropriate contacts for signaling the position of the switch's manually engageable portion. Generally, the construction and operation of the power switch 184 and the controller C for controlling the motor 16 are well known and any construction for these may be used. Also, the switch need not have distinct positions corresponding to on/off/idle, and these conditions may be states selected in the controller C by the operation of the power switch 184. For example, the power switch 184 need not be mechanical and could be of the electro-sensitive type. Likewise, such as switch may be entirely omitted, and the shredder 10 can be started based on insertion of an article to be shredded. As an option, the power switch 184 may also have a reverse position wherein contacts are closed to enable delivery of electrical power to operate the motor 16 in a reverse manner. This would be done by using a reversible motor and applying a current that is of a reverse polarity relative to the on position. The capability to operate the motor 16 in a reversing manner is desirable to move the cutter elements 22, 28 in a reversing direction for clearing jams.

In one embodiment, dimensions noted in the present patent application may be up to 5 percent, 10 percent, 15 percent or 20 percent greater than or up to 5 percent, 10 percent, 15 percent or 20 percent less than the values described throughout the present patent application. In another embodiment, dimensions noted in the present patent application may be in the range of +/−5 percent, +/−10 percent, +/−15 percent or +/−20 percent of the values described throughout the present patent application.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A shredder comprising:
a housing;
a shredder mechanism, the shredder mechanism comprising:
a first rotatable shaft having a first plurality of cutter blades fixedly mounted thereon,
a first plurality of strippers mounted adjacent the first shaft with each of the strippers arranged between a corresponding pair of the cutter blades on the first shaft, each of the strippers of the first plurality having a first lubricant tubing opening formed therethrough, wherein the first lubricant tubing openings are radially offset from the first plurality of strippers and aligned with one another to form a first lubricant tubing passage through the first plurality of strippers; and
a second rotatable shaft having a second plurality of cutter blades fixedly mounted thereon,
a second plurality of strippers mounted adjacent the second shaft with each of the strippers arranged between a corresponding pair of the cutter blades on the second shaft, each of the strippers of the second plurality having a second lubricant tubing opening formed therethrough, wherein the second lubricant tubing openings are radially offset from the second plurality of strippers and aligned with one another to form a second lubricant tubing passage through the second plurality of strippers; and
wherein said first and second shafts are arranged parallel to one another with the cutter blades on each shaft axially interleaved with the blades of the other;
a motor coupled to the shredder mechanism for rotating the shafts in counter-rotating directions to shred articles between the first and second pluralities of cutter blades; and
a lubricant system comprising:
a lubricant reservoir for containing a supply of liquid lubricant;
lubricant delivery tubing communicated in a closed loop to the lubricant reservoir and routed through both the first and second lubricant tubing passages, the closed loop enabling the lubricant to flow from the reservoir, through the lubricant delivery tubing and back to the reservoir, the lubricant delivery tubing being permeable to the liquid lubricant through a surface thereof along portions disposed within the first and second lubricant tubing passages for delivering a portion of the liquid lubricant flowing therethrough to lubricate the strippers and the cutter blades, and
a lubricant pump for pumping the lubricant from the reservoir through the lubricant delivery tubing.

2. The shredder of claim 1, wherein the lubricant delivery tubing is a single lubricant delivery tube routed in one direction through the first lubricant tubing passage and then back in an opposite direction through the second lubricant tubing passage with a bight portion extending between the first and second lubricant tubing passages, the tube having its opposing ends communicated to the reservoir to establish the closed loop.

3. The shredder of claim 1, wherein the lubricant delivery tubing is provided with a plurality of perforations through the surface thereof along the portions disposed within the first and second lubricant tubing passages to be permeable to the liquid lubricant.

4. The shredder of claim 3, wherein the perforations are laser perforated.

5. The shredder of claim 1, wherein the lubricant delivery tubing comprises a first lubricant delivery tube and a second lubricant delivery tube,
the first lubricant delivery tube being routed through the first lubricant tubing passage and the second lubricant delivery tube being routed through the second lubricant tubing passage, each of the lubricant delivery tubes having its opposing ends communicated to the reservoir to establish the closed loop.

6. A shredder configured to shred at least paper, the shredder comprising:
a housing;
a shredder mechanism, the shredder mechanism comprising:
a first rotatable shaft having a first plurality of cutter blades fixedly mounted thereon,
a first plurality of strippers mounted adjacent the first shaft with each of the strippers arranged between a corresponding pair of the cutter blades on the first shaft; and
a second rotatable shaft having a second plurality of cutter blades fixedly mounted thereon,
a second plurality of strippers mounted adjacent the second shaft with each of the strippers arranged between a corresponding pair of the cutter blades on the second shaft; and
wherein said first and second shafts are arranged parallel to one another with the cutter blades on each shaft axially interleaved with the blades of the other;
a motor coupled to the shredder mechanism for rotating the shafts in counter-rotating directions to shred the at least paper between the first and second pluralities of cutter blades; and
a lubricant system comprising:
a lubricant reservoir for containing a supply of liquid lubricant;
one or more lubricant delivery conduits communicated to the lubricant reservoir for delivering a portion of the liquid lubricant flowing therethrough to lubricate the strippers and the cutter blades, and
a lubricant pump for pumping the lubricant from the reservoir through the one or more lubricant delivery conduits;
wherein the strippers of the first and second pluralities comprise strippers having a paper retention opening formed therein, wherein each paper retention opening faces axially for capturing paper particles therein from the paper shredded between the first and second pluralities of cutter blades to enable the captured paper particles to collect the lubricant therein.

7. The shredder of claim 6, wherein each paper retention opening is aligned at least partially with the first or second pluralities of blades such that at least one adjacent blade at least partially overlaps the paper retention opening for contact with the paper particles with collected lubricant when captured therein.

8. The shredder of claim 7, wherein each paper retention opening is formed through a thickness of its stripper and the at least one adjacent blade at least partially overlapping the paper retention opening is a pair of adjacent blades at least partially overlapping the paper retention opening on opposing axial sides thereof.

9. The shredder of claim 8, wherein each paper retention opening has the pair of adjacent blades partially overlapping the paper retention opening on opposing axial sides thereof.

10. The shredder of claim 6, wherein the blades of the first and second pluralities are cross-cut blades with circumferentially extending edges for longitudinally cutting the paper and radially projecting cutting edges for cross-cutting the paper.

11. The shredder of claim 7, wherein the blades of the first and second pluralities are cross-cut blades with circumferentially extending edges for longitudinally cutting the paper and radially projecting cutting edges for cross-cutting the paper.

12. The shredder of claim 8, wherein the blades of the first and second pluralities are cross-cut blades with circumferentially extending edges for longitudinally cutting the paper and radially projecting cutting edges for cross-cutting the paper.

13. The shredder of claim 9, wherein the blades of the first and second pluralities are cross-cut blades with circumferentially extending edges for longitudinally cutting the paper and radially projecting cutting edges for cross-cutting the paper.

14. A shredder configured to shred at least paper, the shredder comprising:
a housing;
a shredder mechanism, the shredder mechanism comprising:
a first rotatable shaft having a first plurality of cutter blades fixedly mounted thereon,
a first plurality of strippers mounted adjacent the first shaft with each of the strippers arranged between a corresponding pair of the cutter blades on the first shaft, each of the strippers of the first plurality having a first anvil portion,
a second rotatable shaft having a second plurality of cutter blades fixedly mounted thereon,
a second plurality of strippers mounted adjacent the second shaft with each of the strippers arranged between a corresponding pair of the cutter blades on the second shaft, each of the strippers of the second plurality having a second anvil portion; and
wherein said first and second shafts are arranged parallel to one another with the cutter blades on each shaft axially interleaved with the blades of the other;
a motor coupled to the shredder mechanism for rotating the shafts in counter-rotating directions to shred the at least paper between the first and second pluralities of cutter blades,
wherein the first anvil portion of each of the strippers of the first plurality is configured to support the at least paper laterally while each of the cutter blades of the second plurality penetrates the at least paper, and
wherein the second anvil portion of each of the strippers of the second plurality is configured to support the at least paper laterally while each of the cutter blades of the first plurality penetrates the at least paper.

15. The shredder of claim 14, wherein each of the strippers of the first plurality is configured to be stationary with respect to the first rotatable shaft, and
wherein each of the strippers of the second plurality is configured to be stationary with respect to the second rotatable shaft.

16. The shredder of claim 15, wherein each of the first anvil portion and the second anvil portion has a non-elongated shaped configuration.

17. The shredder of claim 16, wherein the first anvil portion has a first projection that is either angled or convex shaped so that the cutter blades of the second plurality that are adjacent the first anvil portion are configured to pierce the at least paper near the first projection, and
wherein the second anvil portion has a second projection that is either angled or convex shaped so that the cutter blades of the first plurality that are adjacent the second anvil portion are configured to pierce the at least paper near the second projection.

18. The shredder of claim 17, wherein each of the strippers of the first plurality includes a first paper restrictor portion and a first relief portion, the first relief portion being positioned between the first paper restrictor portion and the first anvil portion, and
wherein each of the strippers of the second plurality includes a second paper restrictor portion and a second relief portion, the second relief portion being positioned between the second paper restrictor portion and the second anvil portion.

19. The shredder of claim 18, wherein the first paper restrictor portion of one of the strippers of the first plurality and the second paper restrictor portion of an adjacent one of the strippers of the second plurality are configured to form a paper receiving opening,
wherein the first relief portion of one of the strippers of the first plurality and the second relief portion of an adjacent one of the strippers of the second plurality are configured to form a relief space, and
wherein the relief space is configured to be wider than the paper receiving opening and the relief space is configured to reduce jamming of the at least paper due to a paper wrinkle or a paper fold.

20. The shredder of claim 19, wherein the first projection and the first paper restrictor portion are configured to create tension on the at least paper as the at least paper passes through the first projection and the paper receiving opening, and
wherein the second projection and the second paper restrictor portion are configured to create tension on the at least paper as the at least paper passes through the second projection and the paper receiving opening.

21. The shredder of claim 20, wherein the paper receiving opening is configured to limit the number or thickness of the at least paper received by the shredder mechanism.

22. The shredder of claim 19, wherein the relief space has a substantially oval shaped configuration.
